(19) United States
(12) Patent Application Publication
(10) Pub. No.: US 2026/0281397 A1
(43) Pub. Date: Sep. 17, 2026

(54) LOCAL ILLUMINATION COMPENSATION MODEL INHERITANCE

(71) Applicant: MEDIATEK INC., Hsinchu City (TW)

(72) Inventors: Cheng-Yen CHUANG, Hsinchu City (TW); Chia-Ming TSAI, Hsinchu City (TW); CHIH-HSUAN LO, Hsinchu City (TW); Ching-Yeh CHEN, Hsinchu City (TW); Yi-Wen CHEN, San Jose, CA (US); Tzu-Der CHUANG, Hsinchu City (TW); Chih-Wei HSU, Hsinchu City (TW); Hsin-Yi TSENG, Hsinchu City (TW)

(21) Appl. No.: 19/472,642

(22) PCT Filed: Jul. 5, 2024
(86) PCT No.: PCT/CN2024/104057

§ 371 Date: Oct. 4, 2025

Related U.S. Application Data
(60) Provisional application No. 63/525,424, filed on Jul. 7, 2023.
(60) Provisional application No. 63/513,905, filed on Jul. 17, 2023.
(60) Provisional application No. 63/589,356, filed on Oct. 11, 2023.
(60) Provisional application No. 63/620,210, filed on Jan. 12, 2024.

(51) Int. Cl. H04N 19/189; H04N 19/105; H04N 19/176; H04N 19/52

(52) U.S. Cl. CPC H04N 19/189; H04N 19/105; H04N 19/176; H04N 19/52

(57) ABSTRACT

A method for using local illumination compensation (LIC) in video coding is provided. A video coder receives data to be encoded or decoded as a current block of pixels of a current picture of a video. The video coder inherits a previously used linear model that is derived based on template samples neighboring two or more previously coded blocks. The video coder applies the inherited linear model to an initial predictor of the current block to generate a final predictor of the current block. The video coder encodes or decodes the current block by using the final predictor. The video coder inherits the linear model by inheriting scaling and offset parameters, as well as information regarding the derivation of the linear model. The linear model may be a spatial candidate, a non-adjacent spatial candidate, a historical candidate, or a temporal candidate.

### CROSS REFERENCE TO RELATED PATENT APPLICATION(S)

The present disclosure is part of a non-provisional application that claims the priority benefit of U.S. Provisional Patent Application Nos. 63/525,424, 63/513,905, 63/589,356, and 63/620,210, filed on 7 Jul. 2023, 17 Jul. 2023, 11 Oct. 2023, and 12 Jan. 2024, respectively. Contents of above-listed applications are herein incorporated by reference.

### TECHNICAL FIELD

The present disclosure relates generally to video coding. In particular, the present disclosure relates to methods of coding pixel blocks by local illumination compensation (LIC).

### BACKGROUND

Unless otherwise indicated herein, approaches described in this section are not prior art to the claims listed below and are not admitted as prior art by inclusion in this section.

High-Efficiency Video Coding (HEVC) is an international video coding standard developed by the Joint Collaborative Team on Video Coding (JCT-VC). HEVC is based on the hybrid block-based motion-compensated DCT-like transform coding architecture. The basic unit for compression, termed coding unit (CU), is a 2N×2N square block of pixels, and each CU can be recursively split into four smaller CUs until the predefined minimum size is reached. Each CU contains one or multiple prediction units (PUs).

Versatile video coding (VVC) is the latest international video coding standard developed by the Joint Video Expert Team (JVET) of ITU-T SG16 WP3 and ISO/IEC JTC1/SC29/WG11. The input video signal is predicted from the reconstructed signal, which is derived from the coded picture regions. The prediction residual signal is processed by a block transform. The transform coefficients are quantized and entropy coded together with other side information in the bitstream. The reconstructed signal is generated from the prediction signal and the reconstructed residual signal after inverse transform on the de-quantized transform coefficients. The reconstructed signal is further processed by in-loop filtering for removing coding artifacts. The decoded pictures are stored in the frame buffer for predicting the future pictures in the input video signal.

In VVC, a coded picture is partitioned into non-overlapped square block regions represented by the associated coding tree units (CTUs). The leaf nodes of a coding tree correspond to the coding units (CUs). A coded picture can be represented by a collection of slices, each comprising an integer number of CTUs. The individual CTUs in a slice are processed in raster-scan order. A bi-predictive (B) slice may be decoded using intra prediction or inter prediction with at most two motion vectors and reference indices to predict the sample values of each block. A predictive (P) slice is decoded using intra prediction or inter prediction with at most one motion vector and reference index to predict the sample values of each block. An intra (I) slice is decoded using intra prediction only.

A CTU can be partitioned into one or multiple non-overlapped coding units (CUs) using the quadtree (QT) with nested multi-type-tree (MTT) structure to adapt to various local motion and texture characteristics. A CU can be further split into smaller CUs using one of the five split types: quad-tree partitioning, vertical binary tree partitioning, horizontal binary tree partitioning, vertical center-side triple-tree partitioning, horizontal center-side triple-tree partitioning.

Each CU contains one or more prediction units (PUs). The prediction unit, together with the associated CU syntax, works as a basic unit for signaling the predictor information. The specified prediction process is employed to predict the values of the associated pixel samples inside the PU. Each CU may contain one or more transform units (TUs) for representing the prediction residual blocks. A transform unit (TU) is comprised of a transform block (TB) of luma samples and two corresponding transform blocks of chroma samples and each TB correspond to one residual block of samples from one color component. An integer transform is applied to a transform block. The level values of quantized coefficients together with other side information are entropy coded in the bitstream. The terms coding tree block (CTB), coding block (CB), prediction block (PB), and transform block (TB) are defined to specify the 2-D sample array of one-color component associated with CTU, CU, PU, and TU, respectively. Thus, a CTU consists of one luma CTB, two chroma CTBs, and associated syntax elements. A similar relationship is valid for CU, PU, and TU.

For each inter-predicted CU, motion parameters consisting of motion vectors, reference picture indices and reference picture list usage index, and additional information are used for inter-predicted sample generation. The motion parameter can be signalled in an explicit or implicit manner. When a CU is coded with skip mode, the CU is associated with one PU and has no significant residual coefficients, no coded motion vector delta or reference picture index. A merge mode is specified whereby the motion parameters for the current CU are obtained from neighboring CUs, including spatial and temporal candidates, and additional schedules introduced in VVC. The merge mode can be applied to any inter-predicted CU. The alternative to merge mode is the explicit transmission of motion parameters, where motion vector, corresponding reference picture index for each reference picture list and reference picture list usage flag and other needed information are signalled explicitly per each CU.

### SUMMARY

The following summary is illustrative only and is not intended to be limiting in any way. That is, the following summary is provided to introduce concepts, highlights, benefits and advantages of the novel and non-obvious techniques described herein. Select and not all implementations are further described below in the detailed description. Thus, the following summary is not intended to identify essential features of the claimed subject matter, nor is it intended for use in determining the scope of the claimed subject matter.

Some embodiments of the disclosure provide a method for using local illumination compensation (LIC) in video coding. A video coder receives data to be encoded or decoded as a current block of pixels of a current picture of a video. The video coder inherits a previously used linear model that is derived based on template samples neighboring two or more previously coded blocks. The video coder applies the inherited linear model to an initial predictor of the current block to generate a final predictor of the current block. The initial predictor may be a reference block identified by a motion vector of the current block. The video coder encodes or decodes the current block by using the final predictor. The video coder inherits the linear model by inheriting scaling and offset parameters, as well as information regarding the derivation of the linear model.

The linear model may be a spatial candidate inherited from a spatial neighbor of the current block. The linear model may be a non-adjacent spatial candidate inherited from a non-adjacent spatial neighbor of the current block. The inherited linear model may be a historical candidate identified by using a history table that stores a history of one or more previously used linear models. The linear model may be a temporal candidate inherited from a neighboring position of a corresponding position of the current block in a reference picture, with the neighboring position constrained to be within a region in the reference picture that is defined based on the corresponding position of the current block in the reference picture.

The video coder may construct a candidate list that includes one or more linear models, and the encoder may inherit the linear model by signaling a selection of the linear model from the constructed candidate list. The candidates in the candidate list may be assigned indices according to modeling errors of the candidates, where the modeling error of a candidate is computed by comparing reconstructed neighboring samples of the current block with samples generated by applying the candidate linear model to neighboring samples of a reference block that is used to produce the initial predictor.

### BRIEF DESCRIPTION OF THE DRAWINGS

The accompanying drawings are included to provide a further understanding of the present disclosure, and are incorporated in and constitute a part of the present disclosure. The drawings illustrate implementations of the present disclosure and, together with the description, serve to explain the principles of the present disclosure. It is appreciable that the drawings are not necessarily in scale as some components may be shown to be out of proportion than the size in actual implementation in order to clearly illustrate the concept of the present disclosure.

FIG. 1 conceptually illustrates local illumination compensation (LIC).

FIG. 2 illustrates the pre-defined positions of spatial neighboring blocks, from which to inherit model parameters.

FIG. 3 conceptually illustrates inheriting temporal neighboring model parameters.

FIGS. 4A-B illustrate temporal candidate positions.

FIGS. 5A-B illustrate non-adjacent spatial neighboring blocks used to derive the spatial merge candidates relative to the current block.

FIGS. 6A-B conceptually illustrate current and reference regions being represented in history tables.

FIG. 7 illustrates the regions available for providing temporal candidates.

FIGS. 8A-D illustrate mapping non-adjacent spatial positions above the current CTU row for referencing LIC information.

FIG. 9 illustrates neighboring templates used for calculating LIC model error.

FIGS. 10A-B illustrate examples of LIC information propagation based on block vectors reference blocks in the current picture.

FIGS. 11A-B illustrate examples LIC information propagation based on motion vectors referencing blocks in reference pictures.

FIG. 12 illustrates propagating LIC information based on both block vector and motion vector.

FIG. 13 illustrates cascading motion vectors and block vectors.

FIG. 14 illustrates an example video encoder that may implement LIC.

FIG. 15 illustrates portions of the video encoder that implement inheriting LIC information.

FIG. 16 conceptually illustrates a process for encoding a block of pixels using an inherited LIC linear model.

FIG. 17 illustrates an example video decoder that may implement LIC.

FIG. 18 illustrates portions of the video decoder that implement inheriting LIC information.

FIG. 19 conceptually illustrates a process for decoding a block of pixels using an inherited LIC linear model.

FIG. 20 conceptually illustrates an electronic system with which some embodiments of the present disclosure are implemented.

### DETAILED DESCRIPTION

In the following detailed description, numerous specific details are set forth by way of examples in order to provide a thorough understanding of the relevant teachings. Any variations, derivatives and/or extensions based on teachings described herein are within the protective scope of the present disclosure. In some instances, well-known methods, procedures, components, and/or circuitry pertaining to one or more example implementations disclosed herein may be described at a relatively high level without detail, in order to avoid unnecessarily obscuring aspects of teachings of the present disclosure.

### I. Cross Component Prediction (CCP)

For chroma coding, in some embodiments, a flag may be signaled to indicate whether CCP mode (including Cross-Component Linear Model, Convolutional Cross-Component Model, Gradient Linear Model and their variants) or non-CCP mode (conventional chroma intra prediction mode, fusion of chroma intra prediction mode) is used. In some embodiments, if the CCP mode is selected, one more flag is signaled to indicate how to derive the CCP type and parameters, i.e., either from a CCP merge list or signaled/derived on-the-fly. A CCP merge candidate list may be constructed from the spatial adjacent, spatial non-adjacent, or history-based candidates. After including these candidates, default models are further included to fill the remaining empty positions in the merge list. In order to remove redundant CCP models in the list, pruning operation is applied. After constructing the list, the CCP models in the list are reordered depending on the SAD costs, which are obtained using the neighboring template of the current block.

In some embodiments, the inherited model parameters can be from a block that is an immediate neighboring block. The models from blocks at pre-defined positions are added into a CCP merge candidate list in a pre-defined order.

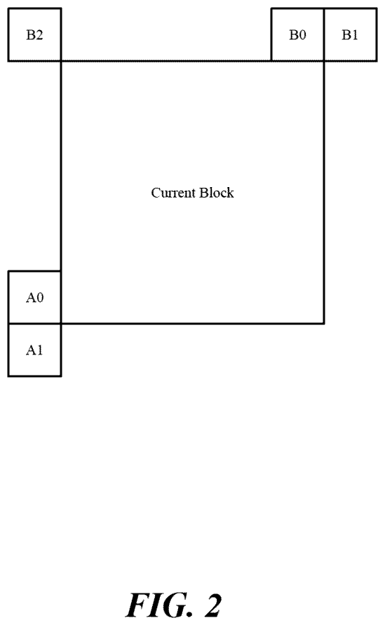

In some embodiments, the pre-defined positions and the pre-defined order can be the same as those of spatial candidates for inter merge mode. FIG. 2 illustrates the pre-defined positions of spatial neighboring blocks, from which to inherit model parameters. The pre-defined order can be B₀, A₀, B₁, A₁ and B₂ as their respective model parameters are added to the CCP merge candidate list.

In some embodiments, a history-based table is maintained to include the recently used CCP models, and the table is reset at the beginning of each CTU row. If the current list is not full after including spatial adjacent and non-adjacent candidates, the CCP models in the history-based table are added into the list as history-based candidates.

In some embodiments, CCLM candidates with default scaling parameters are considered as default candidates, but only when the list is not full after including the spatial adjacent, spatial non-adjacent, or history-based candidates. If the current list has no candidates with the single model CCLM mode, the default scaling parameters are {0, ⅛, −⅛, 2/8, − 2/8, ⅜, −⅜, 4/8, − 4/8, ⅝, −⅝, 6/8}. Otherwise, the default scaling parameters are {0, the scaling parameter of the first CCLM candidate+{⅛, −⅛, 2/8, − 2/8, ⅜, −⅜, 4/8, − 4/8, ⅝, −⅝, 6/8}}. The offset parameter is derived according to the default scaling parameter, average neighboring reconstructed luma sample value, and average neighboring reconstructed Cb/Cr sample value.

In some embodiments, a flag is signaled to indicate whether the CCP merge mode is applied or not. If CCP merge mode is applied, an index is signaled to indicate which candidate model is used by the current block. In addition, CCP merge mode is not allowed for the current chroma coding block when the current CU is coded by intra sub-partitions (ISP) with single tree, or the current chroma coding block size is less than or equal to 16.

### II. Local Illumination Compensation (LIC)

LIC is an inter prediction technique to model local illumination variation between current block and its prediction block as a function of that between current block template and reference block template. The parameters of the function can be denoted by a scale α and an offset β, which forms a linear equation, that is, a*p[x]+B to compensate illumination changes, where p[x] is a reference sample pointed to by MV at a location x on reference picture.

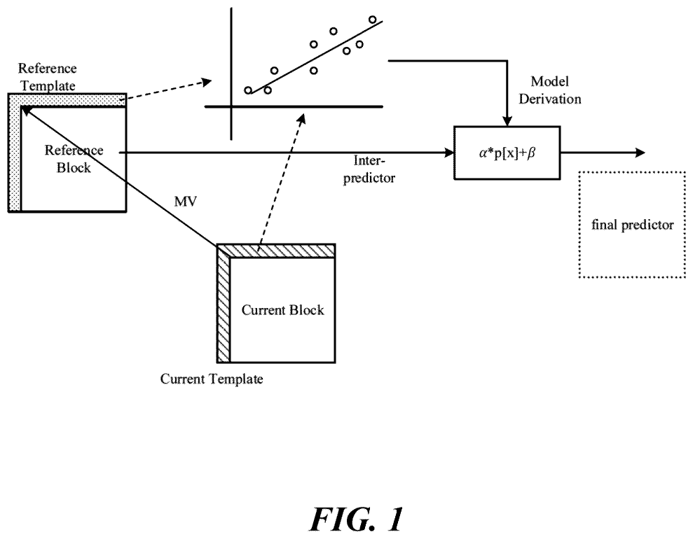

FIG. 1 conceptually illustrates local illumination compensation (LIC). As illustrated, a current block is inter-predicted by having a motion vector (MV) that point to a reference block. The neighboring reconstructed samples of the current block (current block template) and the neighboring reconstructed samples of the reference block (reference block template) are used to calculate the parameters of a linear model a*p[x]+8. The linear model is applied to inter-prediction predictor to generate a final compensated predictor.

When wrap around motion compensation is enabled, the MV may be clipped with wrap around offset taken into consideration. Since a and β can be derived based on current block template and reference block template, no signaling overhead is required for them, except that an LIC flag is signaled for AMVP mode to indicate the use of LIC.

a. LIC with Inter-Prediction

In the example of FIG. 1, LIC is used for uni-prediction inter CUs. In some embodiments, the LIC used for uni-prediction CU is subject to the following conditions: (1) intra neighbor samples can be used in LIC parameter derivation; (2) LIC is disabled for blocks with less than 32 luma samples; (3) for both non-subblock and affine modes, LIC parameter derivation is performed based on the template block samples corresponding to the current CU, instead of partial template block samples corresponding to first top-left 16×16 unit; and (4) samples of the reference block template are generated by using MC with the block MV without rounding it to integer-pel precision.

b. Bi-Predictive LIC

In some embodiments, the LIC mode is extended to bi-predictive CUs. Specifically, two different linear models are applied to the two prediction blocks which are then combined to generate the bi-prediction samples of the current CU, i.e.,

$${P}^{′} [ x , y ] = ( 1 - ω ) \cdot {p}_{0}^{′} [ x , y ] + ω \cdot {p}_{1}^{′} [ x , y ] \\ and \\ {p}_{0}^{′} [ x , y ] = {α}_{0} \cdot {P}_{0} [ x , y ] + {β}_{0} \\ {p}_{1}^{′} [ x , y ] = {α}_{1} \cdot {P}_{1} [ x , y ] + {β}_{1}$$

where α₀ and β₀, and α₁ and β₁ indicate the scales and the offsets in L0 and L1, respectively; ω indicates the weight (as indicated by the CU-level BCW index) for the weighted combination of L0 and L1 predictions. The same derivation scheme of the LIC mode is reused and applied in one iterative manner to derive the L0 and L1 LIC parameters. Specifically, the method firstly derives the L0 parameters by minimizing difference between L0 template prediction T₀ and the template T and the samples in T are updated by subtracting the corresponding samples in T₀. Then, the L1 parameters are calculated that minimizes the difference between L1 template prediction T₁ and the updated template. Finally, the L0 parameter is refined again in the same way.

Following the current LIC design, one flag is signaled for AMVP bi-predicted CUs for the indication of the LIC mode while the flag is inherited for merge related inter CUs. Additionally, the LIC is disabled when decoder-side motion vector refinement (DMVR) (including multi-pass DMVR, adaptive DMVR and affine DMVR) and bi-directional optical flow (BDOF) is applied.

c. OBMC with LIC

In some embodiments, the overlapped block motion compensation (OBMC) is enabled for the inter blocks that are coded with the LIC mode. In some embodiments, to reduce the complexity, the OBMC is only applied to the top and left CU boundaries while being always disabled for the boundaries of the internal sub-blocks of one LIC CU. Additionally, when one neighboring block is coded with the LIC, its LIC parameters are applied to generate the corresponding prediction samples for the OBMC of one current block.

### III. LIC Model Inheritance

a. Inherit LIC Information

In some embodiments, all or part of the LIC information of inherited LIC model may be stored together with the inherited LIC model parameters. The LIC information includes but not limited to template region selection type (e.g., select top template region “LIC_T”, select left template region “LIC_L”, or select left and top template regions “LIC_LT”), size of template region, LIC model type (e.g., linear model ax+b, LIC with location term, or multiple-tap LIC), multi-model flag, classification method for multi-model, threshold for multi-model, or model parameters.

In some embodiments, a single LIC model can be generated from a multi-model LIC. For example, if a candidate is coded with multi-model LIC, a single LIC model can be generated by selecting the first or the second LIC model in the multi-model LIC.

b. Refinement of Inherited LIC Model Parameters

In some embodiments, the parameters of inherited model may be further refined based on the inherited LIC information. The inherited LIC information may include how the inherited model is derived, such as the template region selection type and/or the size of template region. The refined parameters are derived based on local information. The refinement process may follow how the inherited model was derived and use the same type of template and/or the same size of template region.

In some embodiments, the parameters of the inherited model may be further refined based on a pre-defined process. A pre-defined template type and a pre-defined size of template region are used for all types of inherited LIC model.

c. Inherit Spatial Neighboring Model Parameters

In some embodiments, the inherited LIC model parameters may be from a block that is an immediate neighboring block. The models from blocks at pre-defined positions are added into the candidate list in a pre-defined order. For example, the pre-defined positions may be the positions as illustrated in the FIG. 2 above, and the pre-defined order may be B₀, A₀, B₁, A₁ and B₂, or A₀, B₀, B₁, A₁ and B₂.

In some embodiments, the pre-defined positions include the positions at the immediate above (W>>1) or ((W>>1)−1) position if W is greater than or equal to TH, and the positions at the immediate left (H>>1) or ((H>>1)−1) position if H≥TH, where W and H are the width and height of the current block, TH is a threshold value which may be 4, 8, 16, 32, or 64.

In some embodiments, the maximum number of inherited models from spatial neighbors are smaller than the number of pre-defined positions. For example, if there are 5 pre-defined positions and the pre-defined order is B₀, A₀, B₁, A₁ and B₂, and the maximum number of inherited models from spatial neighbors is 4, the model from B₂ is added into the candidate list only when one of preceding blocks is not available or is not coded in LIC model.

d. Inherit Temporal Neighboring Model Parameters

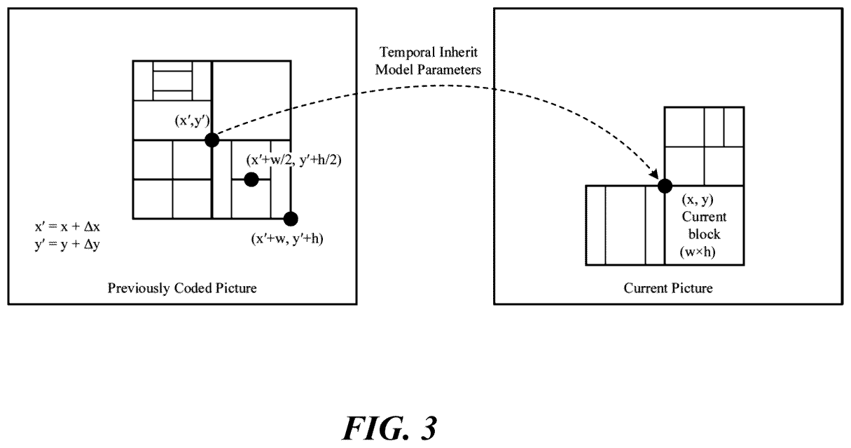

In some embodiments, if the current slice/picture is a non-intra slice/picture, the inherited model parameters may be from the block in the previous coded slices/pictures. FIG. 3 conceptually illustrates inheriting temporal neighboring model parameters. As illustrated, the current block position is at (x, y) and the block size is w×h. The inherited model parameters may be from a block at position (x′, y′), (x′, y′+h/2), (x′+w/2, y′), (x′+w/2, y′+h/2), (x′+w, y′), (x′, y′+h), or (x′+w, y′+h) of the previous coded slices/picture, where x′=x+Δx and y′=y+Δy.

In some embodiments, if the prediction mode of the current block is intra, Δx and Δy are set to 0. If the prediction mode of the current block is inter, Δx and Δy are set to the horizontal and vertical motion vector of the current block. In some embodiments, if the current block is inter bi-prediction, Δx and Δy are set to the horizontal and vertical motion vector in reference picture list 0. In still another embodiment, if the current block is inter bi-prediction, Δx and Δy are set to the horizontal and vertical motion vector in reference picture list 1.

For still another embodiment, if the current block is inter bi-prediction, the inherited model parameters may be from the block in the previous coded slices/pictures in the reference lists. For example, if the horizontal and vertical motion vector in reference picture list 0 is Δx_{L0} and Δy_{L0}, the motion vector could be scaled to other reference pictures in the reference list 0 and 1. If the motion vector is scaled to the i-th reference picture in the reference list 0 as (Δx_{L0,i0}, Δy_{L0,i0}). The model could be from the block in the i^{th} reference picture in the reference list 0, and Δx and Δy are set to (Δx_{L0,i0}, Δy_{L0,i0}). For example, if the horizontal and vertical motion vector in reference picture list 0 is Δx_{L0} and Δy_{L0}, the motion vector is scaled to the i-th reference picture in the reference list 1 as (Δx_{L0,i1}, Δy_{L0,i1}). The model may be from the block in the i-th reference picture in the reference list 1, and Δx and Δy are set to (Δx_{L0,i1}, Δy_{L0,i1}).

In some embodiments, if the current slice/picture is a non-intra slice/picture, the inherited model parameters could be from the block in the previous coded slices/pictures. In some embodiments, the current block position is at (x, y) and the block size is w×h. The two value sets αₓ and α_{y} are defined as:

$${α}_{x} = \{ {α}_{x 1} , {α}_{x 2} , {α}_{x 3} , … , {α}_{xn} \} , {α}_{xi} < {α}_{xj} if i < j \\ {α}_{y} = \{ {α}_{y 1} , {α}_{y 2} , {α}_{y 3} , … , {α}_{yn} \} , {a}_{yi} < {a}_{yj} if i < j$$

All values in αₓ and α_{y} are positive numbers. Let

$$( {x}_{mid} , {y}_{mid} ) = ( x + \frac{w}{2} , y + \frac{h}{2} ) .$$

The inherited model parameters could be from the block at positions (x_{mid}+αₓᵢ×W, y_{mid}+α_{yi}×h), (x_{mid}+αₓᵢ×w, y_{mid}−α_{yi}×h), (x_{mid}−αₓᵢ×w, y_{mid}+α_{yi}×h), (x_{mid}−αₓᵢ×w, y_{mid}−α_{yi}×h), (x_{mid}+αₓᵢ×w, 0), (x_{mid}−αₓᵢ×w, 0), (0, y_{mid}+α_{yi}×h), (0, y_{mid}−α_{yi}×h) of the previous coded slices/picture.

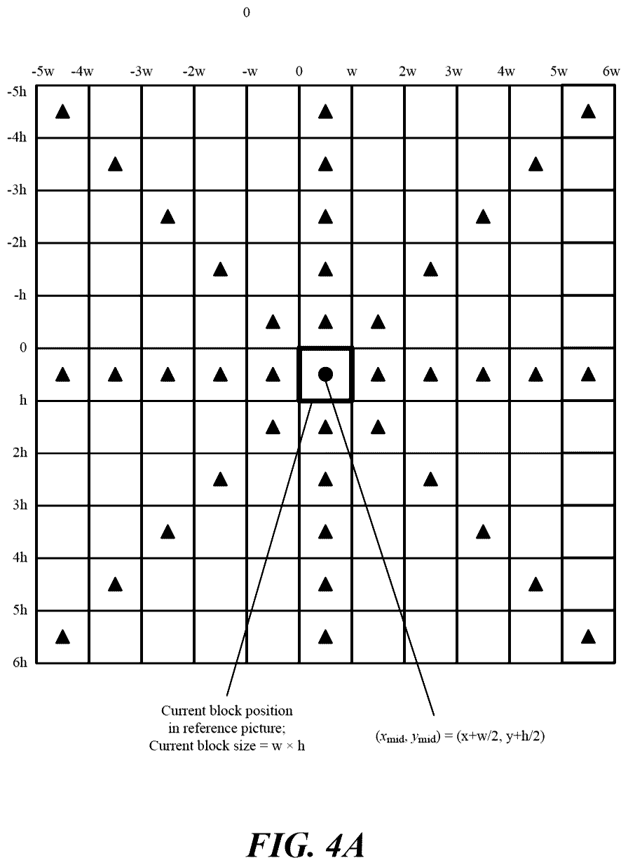

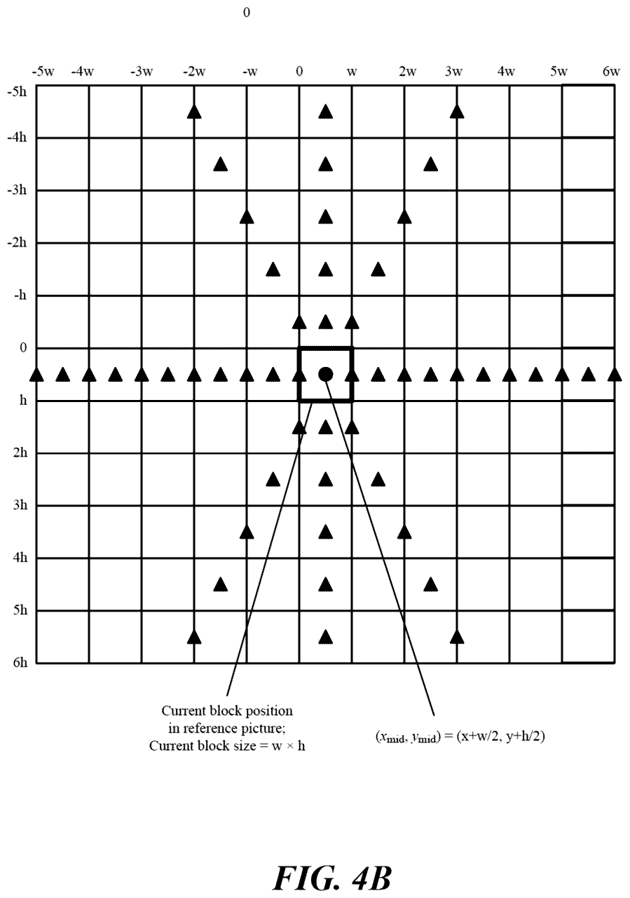

In some embodiments, αₓ=α_{y}. For example, αₓ=α_{y}={1, 2, 3, 4, 5}. The inherited model parameters may be from a block of the previous coded slices/picture at positions depicted in FIG. 4A, which illustrates temporal candidate positions that are in the middle of blocks of a reference picture. The figure shows the position of the current block (not the current block itself) in the reference picture.

In some embodiments, αₓ≠α_{y}. For example,

$${α}_{x} = \{ \frac{1}{2} , 1 , \frac{3}{2} , 2 , \frac{5}{2} \}$$

and α_{y}{1, 2, 3, 4, 5}. The inherited model parameters may be from a block of the previous coded slices/picture at positions depicted in FIG. 4B, which illustrates alternate temporal candidate positions that are denser in the x-direction than in the y-direction.

In some embodiments, the current block position is at (x, y) and the block size is w×h. The inherited model parameters could be from the block at positions (x+αₓᵢ×w, y+α_{yi}×h), (x+αₓᵢ×w, y−α_{yi}×h), (x−αₓᵢ×w, y+α_{yi}×h), (x−αₓᵢ×w, y−α_{yi}×h), (x+αₓᵢ×w, 0), (x−αₓᵢ×w, 0), (0, y+α_{yi}×h), (0, y−α_{yi}×h) of the previous coded slices/picture.

In some embodiments, the models from the positions closer to (x_{mid}, y_{mid}) are added into the final merge candidate list first. In some embodiments, the models from the positions closer to (x, y) are added into the final merge candidate list first.

In some embodiments, let δx and δy be two fixed positive numbers. The inherited model parameters may be from positions (x_{mid}+αₓᵢ×δx, y_{mid}+α_{yi}×δy), (x_{mid}+αₓᵢ×δx, y_{mid}−α_{yi}×δy), (x_{mid}−αₓᵢ×δx, y_{mid}+α_{yi}×δy), (x_{mid}−αₓᵢ×δx, y_{mid}−α_{yi}×δy), (x_{mid}+αₓᵢ×δx, 0), (x_{mid}−αₓᵢ×δx, 0), (0, y_{mid}+α_{yi}×δy), (0, y_{mid}−α_{yi}×δy) of a block of the previous coded slices/picture the block.

In some embodiments, the current block position is at (x, y) and the block size is w×h. Let δx and δy be two fixed positive numbers The inherited model parameters may be at positions (x+αₓᵢ×δx, y+α_{yi}×δy), (x+αₓᵢ×δx, y−α_{y}×δγ), (x−αₓᵢ×δx, y+α_{yi}×δγ), (x−αₓᵢ×δx, y−α_{yi}×δγ), (x+αₓᵢ×δx, 0), (x−αₓᵢ×δx, 0), (0, y+α_{yi}×δy), (0, y−α_{yi}×δy) of a block of the previous coded slices/picture.

In some embodiments, the current block position is at (x, y) and the block size is w×h. The inherited model parameters could be from the block at some pre-defined positions (x′, y′) of the previous coded slices/picture. For one example, the positions are inside the corresponding area of the current encoding block, i.e., x≤x′<x+w and y≤y′<y+h. The inherited model parameters could be from the block at positions (x, y), (x+w−1, y), (x, y+h−1), (x+w−1, y+h−1),

$$( x + \frac{w}{2} , y + \frac{h}{2} ) .$$

For another example, the positions are outside of the corresponding area of the current encoding block, i.e., x′<x+ or x′≥x+w, and y′<y or y′≥y+h. The inherited model parameters could be from the block at (x−1, y), (x, y−1), (x−1, y−1), (x+w, y), (x+w−1, y−1), (x+w, y−1), (x, y+h), (x−1, y+h−1), (x−1, y+h), (x+w, y+h−1), (x+w−1, y+h), (x+w, y+h)

In some embodiment, the previous coded picture the inherited parameter model is from, i.e., the collocated picture, is one of the pictures in the reference lists. In some embodiments, the collocated picture is signaled in the picture/slice header. The reference list and the reference index are signaled in the picture/slice header. For example, the collocated picture is selected as L0[0]. For another example, the collocated picture is selected as L1[0].

In some embodiments, the collocated picture is selected as the picture in the reference lists whose picture order count (POC) difference between it and the current picture is the smallest. For example, if the POC of current picture is 8, the POCs of pictures in reference list 0 are {7, 6, 5, 0} and POCs of pictures in reference list 1 are {7, 6, 5, 4}, then L0[0] (equivalent to L1[0]) is selected since its POC difference is the smallest. In some embodiments, if there are two pictures whose respective POC differences with the current picture are both the smallest, the picture with the smaller POC is selected. For example, if the POC of current picture is 2, the POCs of pictures in reference list 0 are {0, 4, 8} and POCs of pictures in reference list 1 are {8, 16, 32}, then L0[0] (POC=0) is selected.

In some embodiment, if there are two pictures whose respective POC differences with the current picture are both the smallest, the picture with the larger POC is selected. For example, if the POC of current picture is 2, the POCs of pictures in reference list 0 are {0, 4, 8} and POCs of pictures in reference list 1 are {8, 16, 32}, then L0[1] (POC=4) is selected. In some embodiments, if there are two pictures whose respective POC differences with the current pictures are both the smallest, the picture with smaller QP difference between it and the current picture is selected. For example, if the POC of current picture is 2, and the QP of current picture is 28. The POCs and QPs of the pictures in reference list 0 are {0, 4, 8} and {19, 26, 23}. The POCs and QPs of the pictures in reference list 1 are {8, 16, 32} and {23, 22, 21}. Then L0[1] (POC=4 and QP=26) is selected. In some embodiments, if there are two pictures whose respective POC differences with the current picture are both the smallest, the picture with the smaller QP is selected. In some embodiments, if there are two pictures whose respective POC differences with the current picture are both the smallest, the picture with the larger QP is selected.

In some embodiments, the collocated picture is selected as the picture in the reference lists whose QP difference between it and the current picture is the smallest. For example, if the QP of current picture is 28, and the QPs of the pictures in reference list 0 are {19, 26, 23} and the QPs of the pictures in reference list 1 are {23, 22, 21}. Then L0[1] is selected. In some embodiments, if there are more than one pictures in the reference lists whose respective QP differences with the current picture are the smallest, the picture with the smaller QP is selected. In some embodiments, if there are more than one pictures whose respective QP differences with the current picture are the smallest, the picture with the larger QP is selected. In some embodiments, if there are more than one pictures whose respective QP differences with the current picture are the smallest, the picture with the smaller POC distance is selected.

In some embodiments, the collocated picture is selected as the picture in the reference lists whose QP is the smallest. In some embodiments, the collocated picture is selected as the picture in the reference lists whose QP is the largest. In some embodiments, the previous coded picture the inherited parameter model is from, i.e., the collocated picture, is the most recently coded I-picture. The LIC model information of the most recently coded I-slice/picture is stored in a long-term reference buffer.

In some embodiments, the collocated picture and the position where the inherited parameter model is from is determined by the motion vector of a neighboring block. For example, if the current block position is at (x, y) and the block size is w×h. The inherited model parameters could be from the block at position (x′, y′), (x′, y′+h/2), (x′+w/2, y), (x′+w/2, y′+h/2), (x′+w, y′), (x′, y′+h), or (x′+w, y′+h) of the collocated picture, where x′=x+Δx and y′=y+Δy. Δx and Δy are set to the L0 horizontal and vertical motion vector of the neighboring block, and the collocated picture is the L0 reference picture indicated by the L0 motion vector of the neighboring block. In still another embodiment, if the neighboring block is inter bi-prediction, Δx and Δy are set to the L1 horizontal and vertical motion vector of the neighboring block, and the collocated picture is the L1 reference picture indicated by the L1 motion vector of the neighboring block. In one embodiment, the neighboring block is the left block of the current block. In another embodiment, the neighboring block is the above block of the current block.

In some embodiment, the positions in the previous coded slices/pictures where the inherited parameter model is from is determined by the motion vector of a neighboring block. Let Δx and Δy be the horizontal and vertical displacement determined based on the selected motion vector of the neighboring block, the current block position is at (x, y) and the block size is w×h. The inherited model parameters could be from the block at position (x′, y′), where x′=x+Δx and y′=y+Δy, or where x′=x+w/2+Δx and y′=y+h/2+Δy.

In some embodiments, the inherited model parameters could also be from the block positions in the patterns described above. The positions are centered at (x′, y′). For example, let the current block size be w×h. The two value sets αₓ and α_{y} are defined as:

$${α}_{x} = \{ {α}_{x 1} , {α}_{x 2} , {α}_{x 3} , … , {α}_{xn} \} , {α}_{xi} < {α}_{xj} if i < j \\ {α}_{y} = \{ {α}_{y 1} , {α}_{y 2} , {α}_{y 3} , … , {α}_{yn} \} , {a}_{yi} < {a}_{yj} if i < j$$

All values in αₓ and α_{y} are positive numbers. The inherited model parameters may be from a block of the previous coded slices/picture at positions (x′+αₓᵢ×w, y′+α_{yi}×h), (x′+αₓᵢ×w, y′−α_{yi}×h), (x′−αₓᵢ×w, y′+α_{yi}×h), (x′−αₓᵢ×w, y′−α_{yi}×h), (x′+αₓᵢ×w,0), (x′−αₓᵢ×w, 0), (0, y′+α_{yi}×h), (0,y′−α_{yi}×h). For another example, let δx and δy be two fixed positive numbers. The inherited model parameters may be from a block of the previous coded slices/picture at positions (x′+αₓᵢ×δx, y′+α_{yi}×δy), (x′+αₓᵢ×δx, y′−α_{yi}×δy), (x′−αₓᵢ×δx, y′+α_{yi}×δy), (x′−αₓᵢ×δx, y′−α_{yi}×δy), (x′+αₓᵢ×δx, 0), (x′−αₓᵢ×δx, 0), (0, y′+α_{yi}×δy), (0, y′−α_{yi}×δy).

For another example, the inherited model parameters could be from the block at some pre-defined positions relative to (x′, y′) of the previous coded slices/picture. The positions could be (x′, y′), (x′+w−1, y′), (x′, y′+h−1), (x′+w−1, y′+h−1),

$$( {x}^{′} + \frac{w}{2} , {y}^{′} + \frac{h}{2} ) .$$

For another example, the positions may be

$$( {x}^{′} - 1 , {y}^{′} ) , ( {x}^{′} , {y}^{′} - 1 ) , ( {x}^{′} - 1 , {y}^{′} - 1 ) , ( {x}^{′} + w , {y}^{′} ) , ( {x}^{′} + w - 1 , {y}^{′} - 1 ) , \\ ( {x}^{′} + w , {y}^{′} - 1 ) , ( {x}^{′} , {y}^{′} + h ) , ( {x}^{′} - 1 , {y}^{′} + h - 1 ) , ( {x}^{′} - 1 , {y}^{′} + h ) , \\ ( {x}^{′} + w , {y}^{′} + h - 1 ) , ( {x}^{′} + w - 1 , {y}^{′} + h ) , ( {x}^{′} + w , {y}^{′} + h )$$

In some embodiments, the neighboring block may be at a pre-defined position. For example, the pre-defined position may be A₀, or A₁, or B₀, or B₁, or B₂ (as described by reference to FIG. 2 above). If the block at the pre-defined position is not an inter block, no neighboring block is selected.

In some embodiments, when selecting the neighboring block, there is a list of pre-defined positions according to a checking order, and the positions may be the spatial position described in Section III.c above. The selected neighboring block may be the first position in the list that is an inter block. The L0 motion vector is selected. If the L0 motion vector is not available, select the L1 motion vector. For another example, the L1 motion vector is selected. If the L1 motion vector is not available, select the L0 motion vector.

For another example, the positions in the list are checked in the pre-defined checking order. For each position, the L0 motion vector is first checked, and then the L1 motion vector. For another example, the L1 motion vector is first checked, and then the L0 motion vector. The selected motion vector is the first whose reference picture is the collocated picture.

In some embodiments, the horizontal and vertical displacement Δx and Δy are determined based on the selected motion vector of the neighboring block. For example, if the reference picture of the selected motion vector and the collocated picture are the same picture, Δx equals to the horizonal part of the selected motion vector and Δy equals to the vertical part of the selected motion vector. If the horizonal part or the vertical part of the selected motion vector is fractional, Δx equals to the horizonal part of the selected motion vector after rounding and Δy equals to the vertical part of the selected motion vector after rounding. The rounding method used may be but not limited to the following methods: rounding toward negative infinity, rounding toward positive infinity, rounding toward zero, or rounding to the nearest integer (e.g., rounding away from zero, rounding half up, rounding half down, . . . ).

For another example, if the reference picture of the selected motion vector and the collocated picture are not the same. The reference picture may be one of the pictures in the reference list, while the collocated picture is signaled in the picture/slice header. Let the POC distance between the current picture and the reference picture of the selected motion vector be tb, and the POC distance between the current picture and the collocated picture be td, the selected motion vector be (mv_x, mv_y). Δx=mv_x*(td/tb) and Δy=mv_y*(td/tb). If mv_x*(td/tb) or mv_y*(td/tb) is fractional, Δx equals to the horizonal part of the selected motion vector after rounding and Δy equals to the vertical part of the selected motion vector after rounding. The rounding method used could be but not limited to the following methods: rounding toward negative infinity, rounding toward positive infinity, rounding toward zero, or rounding to the nearest integer (e.g., rounding away from zero, rounding half up, rounding half down, . . . ).

In some embodiments, the inherited model parameters are derived by using the reconstruction samples of the collocated block. Let the current block position be at (x, y) and the block size w×h. The collocated block is a block positioned at (x′, y′) in the collocated picture with block size w×h, when the inherited model is from position (x′, y′). For another example, the collocated block could be a block positioned at (x′, y′) in the collocated picture with block size m×n, where m and n are fixed positive values. For example, the collocated block could be at (x, y). For another example, if Δx and Δy are the L0 horizontal and vertical motion vector of the neighboring block, and the collocated picture is the L0 reference picture indicated by the L0 motion vector of the neighboring block, the collocated block could be at (x+Δx, y+Δy) in the collocated picture. (x′, y′) may be the block positions in the patterns described in earlier paragraphs. For example, (x′, y′) may be (x+αₓᵢ×w, y+α_{yi}×h), (x+αₓᵢ×w, y−α_{yi}×h), (x−αₓᵢ×w, y+α_{yi}×h), (x−αₓᵢ×w, y−α_{yi}×h), (x+αₓᵢ×w, 0), (x−αₓᵢ×w, 0), (0, y+α_{yi}×h), (0, y−α_{yi}×h).

In some embodiment, the model may be inherited from more than one previous coded pictures. The model parameter could be inherited from any picture in a picture set, which contains N previous coded pictures. An index could be signaled in or parsed from the bitstream to indicate the selected picture. The index ranges from 0 to N−1. In some embodiments, the picture whose POC difference with the current picture is smaller is associated with the smaller index. In some embodiments, the picture whose QP difference with the current picture is smaller is associated with the smaller index. In some embodiments, the picture whose QP is smaller is associated with the smaller index. In some embodiments, the picture whose QP is larger is associated with the smaller index.

e. Inherit Non-Adjacent Spatial Neighboring Models

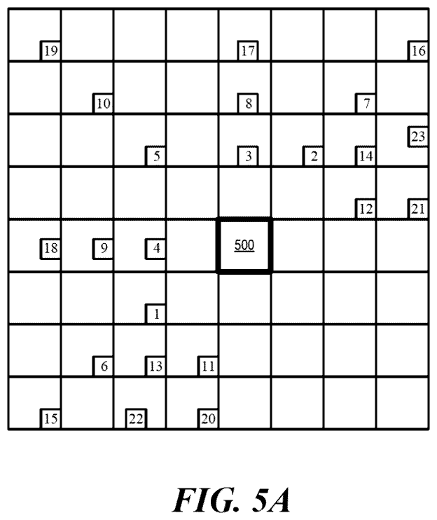

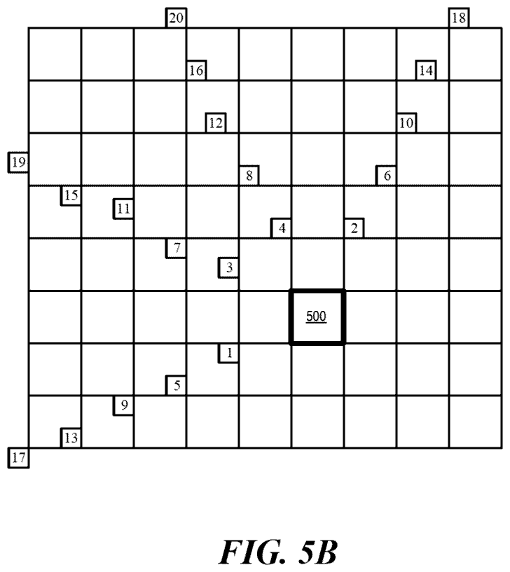

In some embodiments, the inherited model parameters may be from blocks that are spatial neighboring blocks. The models from blocks at pre-defined positions are added into the candidate list in a pre-defined order. For example, the pattern of the positions and order may be as the pattern depicted in FIGS. 5A-B, which illustrate non-adjacent spatial neighboring blocks used to derive the spatial merge candidates relative to the current block. FIG. 5A and FIG. 5B also show, for a current block 500, two different search patterns for pre-defined positions in non-adjacent spatial neighbors from which to inherit models.

In the examples of FIGS. 5A-B, the distances between any two neighboring positions are equal to the width or the height of the current block. In some other embodiments, the distances between the positions that are closer to the current block may be smaller than the positions that are further away from the current block. In some other embodiments, the distance between the positions that are closer to the current block may be larger than the positions that are further away from the current block.

For some embodiments, the maximum number of inherited models from non-adjacent spatial neighbors are smaller than the number of pre-defined positions. If the maximum number of inherited models from non-adjacent spatial neighbors is N, the search pattern 2 is used only when the number of available models from search pattern 1 is smaller than N.

In some embodiments, let the current block position be (x, y) and the block size be w×h. The two value sets αₓ and dy are defined as:

$${α}_{x} = \{ {α}_{x 1} , {α}_{x 2} , {α}_{x 3} , … , {α}_{xn} \} , {α}_{xi} < {α}_{xj} if i < j \\ {α}_{y} = \{ {α}_{y 1} , {α}_{y 2} , {α}_{y 3} , … , {α}_{yn} \} , {a}_{yi} < {a}_{yj} if i < j$$

All values in αₓ and α_{y} are positive numbers. Let x′=x+Δx and y′=y+Δy. The inherited model parameters could be from the positions determined by x′ and y′. For example, the inherited model parameters could be from the block at positions (x′+αₓᵢ×w, y′+α_{yi}×h), (x′+αₓᵢ×w, y′−α_{yi}×h), (x′−αₓᵢ×w, y′+α_{yi}×h), (x′−αₓᵢ×w, y′−α_{yi}×h), (x′+αₓᵢ×w,0), (x′−αₓᵢ×w,0), (0, y′+α_{yi}×h), (0, y′−α_{yi}×h). For another example, let δx and δy be two fixed positive numbers. The inherited model parameters may be from the block at positions (x′+αₓᵢ×δx, y′+α_{yi}×δy), (x′+αₓᵢ×δx, y′−α_{yi}×δy), (x′−αₓᵢ×δx, y′+α_{yi}×δy), (x′−αₓᵢ×δx, y′−α_{yi}×δy), (x′+αₓᵢ×δx, 0), (x′−αₓᵢ×δx, 0), (0, y′+α_{yi}×δy), (0, y′−α_{yi}×δy). For another example, the inherited model parameters may be from the block at some pre-defined positions relative to (x′, y′) of the previous coded slices/picture. The positions could be (x′, y′), (x′+w−1, y′),(x′, y′+h−1), (x′+w−1, y′+h−1),

$$( {x}^{′} + \frac{w}{2} , {y}^{′} + \frac{h}{2} ) .$$

For another example, the positions may be (x′−1, y′), (x′, y′−1), (x′−1, y′−1), (x′+w, y′), (x′+w−1, y′−1), (x′+w, y′−1), (x′, y′+h), (x′−1, y′+h−1), (x′−1, y′+h), (x′+w, y′+h−1), (x′+w−1, y′+h), (x′+w, y′+h). For another example, the position could be (x′, y′), (x′, y′+h/2), (x′+w/2, y′), (x′+w/2, y′+h/2), (x′+w, y′), (x′, y′+h), or (x′+w, y′+h).

In some embodiments, Δx and Δy could be set according to the horizontal and vertical block vector of a neighboring block. For example, Δx and Δy may be equal to the horizontal and vertical block vector of a neighboring block.

f. Inherit Model Parameters from History Table

In some embodiments, the inherited model parameters may be from a LIC model history table. The models in the history table may be added into the candidate list according to a pre-defined order. In some embodiments, the adding order of historical candidate may be from the beginning of the table to the end of the table. In some embodiments, the adding order of historical candidate may be from a certain pre-defined position to the end of the table. In some embodiments, the adding order of historical candidate may be from the end of the table to the beginning of the table. In some embodiments, the adding order of historical candidate may be from a certain pre-defined position to the beginning of the table. In some embodiments, the adding order of historical candidate may be in an interleaved manner (e.g., the first added candidate is from the beginning of the table, the second added candidate is from the end of the table and so on).

In some embodiments, single LIC model history table could be maintained for storing the previous LIC model, and the history table could be reset at the start of the current picture, current slice, current tile, every M CTU rows or every N CTUs, N and M could be any value greater than 0. In some embodiments, the LIC model history table may be reset at the end of the current picture, current slice, current tile, current CTU row or current CTU.

In some embodiments, one picture could be divided into several regions, and for each region, a history table is kept. The history table 0 and one additional history table will be updated during the encoding/decoding process. The additional history table could be determined by the current position. For example, if the current CU locates in the second region, the additional history table to be updated is history table 2.

In some embodiments, multiple history tables are used for different updated frequency. For example, the first history table is updated every CU, the second history table is updated every two CUs, the third history table is updated every four CUs and so on.

In some embodiments, multiple history tables are used for storing different type of LIC model. For example, the first history table is used for storing single model, and the second history table is used for storing multi-model.

In some embodiments, multiple history tables are used for different intensity of reconstructed sample. For example, if the average of the reconstructed samples intensity in the neighboring of current block are greater than a pre-defined threshold, the LIC model will be stored in the first history table; otherwise, the LIC model will be store in the second history table.

In some embodiments, when adding historical candidates from multiple history tables to the candidate list, the adding order could be from the beginning of the certain table to the end of the certain table, and then add the next history table in the same order or in a reversed order. In some embodiments, the adding order may be from the end of the certain table to the beginning of the certain table, and then add the next history table in the same order or in a reversed order. In some embodiments, the adding order could be from the certain pre-defined position of the certain table to the end of the certain table, and then add the next history table in the same order or in a reversed order. In some embodiments, the adding order may be from the certain pre-defined position of the certain table to the beginning of the certain table, and then add the next history table in the same order or in a reversed order. In some embodiments, the adding order of historical candidate may be in an interleaved manner in a certain history table (e.g., the first added candidate is from the beginning of the certain history table, the second added candidate is from the end of the certain history table and so on), and then add the next history table in the same order or in a reversed order.

In some embodiments, the adding order could be from the beginning of each history table to the end of each history table. In some embodiments, the adding order could be from the end of each history table to the beginning of each history table. In some embodiments, the adding order could be from the certain pre-defined position of each history table to the end of each history table. In some embodiments, the adding order could be from the certain pre-defined position of each history table to the beginning of each history table. In another embodiment, the adding order of historical candidate could be in an interleaved manner in each certain history table (e.g., the first added candidates are from the beginning of all history table, the second added candidates are from the end of all history table and so on).

In some embodiments, multiple history tables are used, but not all history tables will be used for creating the candidate list. Only history tables whose regions are close to the region of current block may be used to create the candidate list. In some embodiments, if the historical candidates are used, the range for selecting non-adjacent candidates may be reduced by using smaller distance between each position of non-adjacent candidate. In some embodiments, if the historical candidates are used, the number of non-adjacent candidates could be reduced by measuring the distance from the left-top position of the current block to the candidate position, and then exclude the candidate with the distance greater than a pre-defined threshold. In some embodiments, if the historical candidates are used, the number of non-adjacent candidates may be reduced by skipping the candidates that are not located in the same region. In some embodiments, if the historical candidates are used, the number of non-adjacent candidates may be reduced by skipping the candidates that are not located in the neighboring regions. The range of neighboring regions is pre-defined, and it may be M by N regions where M and N may be any value greater than 0. In some embodiments, if the historical candidates are used, the range for selecting non-adjacent candidates may be reduced by skipping the second search pattern.

In some embodiments, one picture may be divided into several regions, and at least one history table is kept in each region. For a region of the current picture, it may use or combine the history tables of one or multiple regions in the previous coded pictures as the initial history table. For example, if a picture is divided into N regions, it may implicitly or explicitly select the history table from one of N regions in the previously coded pictures as the initial history table. The index of one of N regions could be signaled or implicitly derived from the corresponding region in the previous coded pictures.

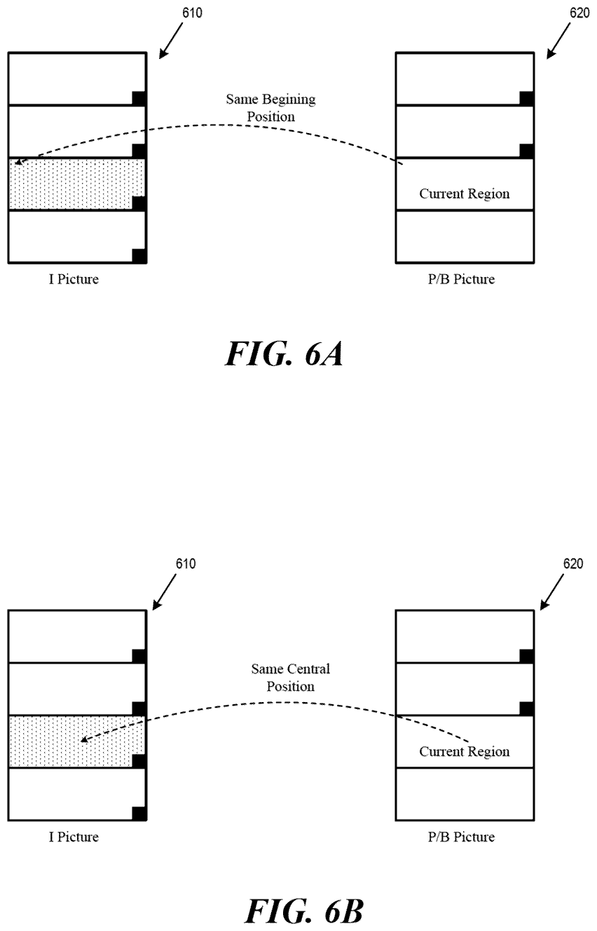

FIGS. 6A-B conceptually illustrate current and reference regions being represented in history tables. The current region is represented by an entry in a history table 620 of the current picture (P/B picture) and the reference region is represented by an entry in a history table 610 of the reference picture (I picture). FIG. 6A illustrates a reference region having a same beginning geometric position as the current region. FIG. 6B illustrates a reference region containing the same center geometric position of the current region. As illustrated, the corresponding region in the previous coded pictures may be the region that has the same beginning geometric position of the current region or contains the center geometric position of the current region. For another example, a video coder may combine more than one history tables in the previous coded regions/pictures to construct the history table of the current region.

g. Available Regions of Temporal Candidates

In some embodiments, to limit the requirement buffer/storage resource, the available range for including temporal candidates are constrained. The temporal candidates mentioned in this section refer to candidates that inherits model parameters from a block in the previous coded slices/pictures, as described in Section III.d above “Inherit temporal neighboring model parameters”. For example, assume the current block position is at (x, y), the positions in the previous coded slices/pictures where the inherited parameter model is from could be (x+Δxᵢ, y+Δyᵢ), i is from 1 to M, and M is a positive integer greater than 0. Δxᵢ and Δyᵢ are pre-defined displacements.

For another example, assume the current block position is at (x, y), the positions in the previous coded slices/pictures where the inherited parameter model is from could be (x+dx+Δxᵢ, y+dy+Δyᵢ), i is from 1 to M, and M is a positive integer greater than 0. Δxᵢ and Δyᵢ are pre-defined displacements, dx and dy are determined by a motion vector of a neighboring block of the current block. The details of how to determine the motion vector is described in Section III.d above.

For another example, assume the current block position is at (x, y), the positions in the previous coded slices/pictures where the inherited parameter model is from may be (x+dx+Δxᵢ, y+dy+Δyᵢ), i is from 1 to M, and M is a positive integer greater than 0. Δxᵢ and Δyᵢ are pre-defined displacements. If the prediction mode of the current block is inter, dx and dy are set to the horizontal and vertical part of motion vector of the current block. If the horizontal part or the vertical part of the motion vector is fractional, dx is set to the horizonal part of the motion vector after rounding and dy is set to the vertical part of the motion vector after rounding. The rounding method used could be but not limited to the following methods: rounding toward negative infinity, rounding toward positive infinity, rounding toward zero, rounding to the nearest integer (e.g., rounding away from zero, rounding half up, rounding half down, . . . ), or rounding to the nearest pre-defined precision (e.g., round to the nearest k-pixel or 1/k-pixel precision position, where k could be 2, 4, 8, 16, or 32). If the prediction mode of the current block is IBC, dx and dy are set to the horizontal and vertical block vector of the current block. If the horizontal part or the vertical part of the block vector is fractional, dx is set to the horizonal part of the block vector after rounding and dy is set to the vertical part of the block vector after rounding. The rounding method used could be but not limited to the following methods: rounding toward negative infinity, rounding toward positive infinity, rounding toward zero, rounding to the nearest integer (e.g., rounding away from zero, rounding half up, rounding half down, . . . ), or rounding to the nearest pre-defined precision (e.g., round to the nearest k-pixel or 1/k-pixel precision position, where k could be 2, 4, 8, 16, or 32).

In some embodiment, only the LIC information of the collocated picture in the CTU whose position in the collocated picture corresponds to the position of the current encoding CTU in the current picture can be referenced by temporal candidates. In some embodiments, only the LIC information of the collocated picture in the CTUs whose positions in the collocated picture correspond to the position of current encoding CTU, and/or left N CTUs, and/or right M CTUs in current picture can be referenced by temporal candidates, where N and M can be any integer greater than 0. In some embodiments, only the LIC information of the collocated picture in the CTU row whose position in collocated picture corresponds to the position of current encoding CTU row in current picture can be referenced by temporal candidates. In some embodiments, only the positions in collocated picture correspond to current CTU row and/or the above N CTU rows and/or below M CTU rows of the current picture can be referenced, where N and M may be any integer greater than 0. As described in Sections III.a and III.b above, the LIC information mentioned in this disclosure includes but is not limited to template region selection type (e.g., LIC_T, LIC_L or LIC_LT), size of template region, LIC model type (e.g., linear model ax+b, LIC with location term, or multiple-tap LIC), multi-model flag, classification method for multi-model, threshold for multi-model, or model parameters.

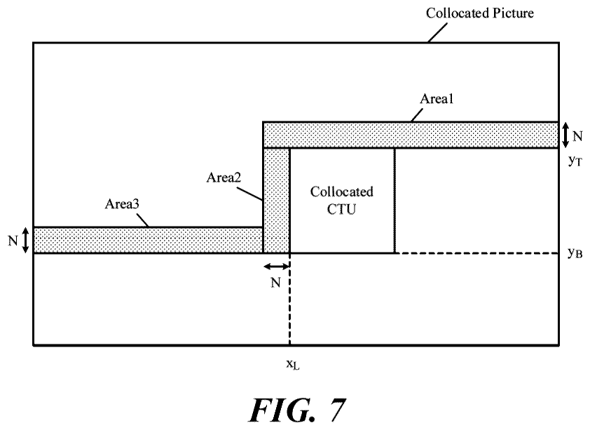

FIG. 7 illustrates the regions available for providing temporal candidates. In the figure, the collocated CTU refers to the CTU in the collocated picture whose position corresponds to the position of the current encoding CTU in the current picture. Let the position of the top-left and bottom left corner of the collocated CTU be (x_{L}, y_{T}) and (x_{L}, y_{B}) respectively. Let the picture width be w. The x, y ranges for each dotted area are defined as following:

$$\begin{matrix}\text{Area1:} {x}_{L} - N \leq x < w , {y}_{T} - N \leq y < {y}_{T} \\ \text{Area2:} {x}_{L} - N \leq x < {x}_{L} , {y}_{T} \leq y \leq {y}_{B} \\ \text{Area3:} 0 \leq x < {x}_{L} - N , {y}_{B} - N < y \leq {y}_{B}\end{matrix}$$

N is any positive integer, N>0.

In some embodiments, the temporal candidates may only refer the LIC information in the collocated CTU, in Area1, in Area2 or in Area3, as depicted in FIG. 7. N is set to a pre-defined value. For example, N is set to the minimum allowed block size in the spec. The block could be CU/PU/TU. For another example, N is set to 4. In some embodiments, the region from which the temporal candidates can refer the LIC information is the same as the region from which the temporal motion vector could be referred in inter mode.

h. Available Regions of Non-Adjacent Spatial Candidates

In some embodiments, to limit the requirement of buffer/storage resource, the available range for including non-adjacent spatial candidates are constraint. In some embodiments, only the LIC information in the current CTU can be referenced by non-adjacent spatial candidate. In some embodiments, only the LIC information in the current CTU or left M CTUs can be referenced by non-adjacent spatial candidate, where M can be any integer greater than 0. In some embodiments, only the LIC information in the current CTU row can be referenced by non-adjacent spatial candidate. In some embodiments, only the to-be-referenced position within the current CTU row or the above N CTU rows can be referenced, where N can be any integer greater than 0. The LIC information mentioned in this disclosure includes but not limited to template region selection type (e.g., LIC_T, LIC_L or LIC_LT), size of template region, LIC model type (e.g., linear model ax+b, LIC with location term, or multiple-tap LIC), multi-model flag, classification method for multi-model, threshold for multi-model, or model parameters.

In some embodiments, the LIC information in the current CTU, current CTU row, current CTU row+above N CTU rows, current CTU+left M CTUs, or current CTU+above N CTU rows+left M CTUs can be referenced without limits, and the LIC information in other regions can only be referenced by a larger pre-defined unit. For example, the LIC information in current CTU row may be stored within 4×4 grid, and for other LIC information outside current CTU row is stored within 16×16 grid. That is, one 16×16 region only needs to store one LIC information, so the to-be-referenced position shall be rounded to 16×16 grid or changed to the nearest position of 16×16 grid.

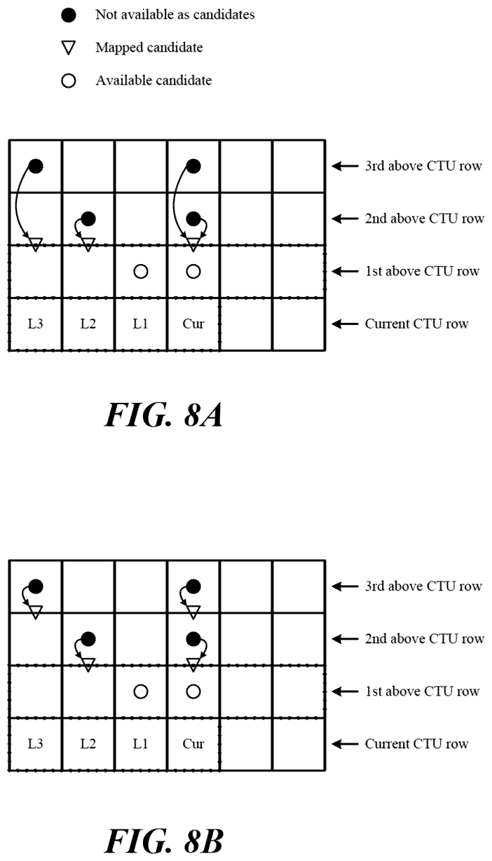

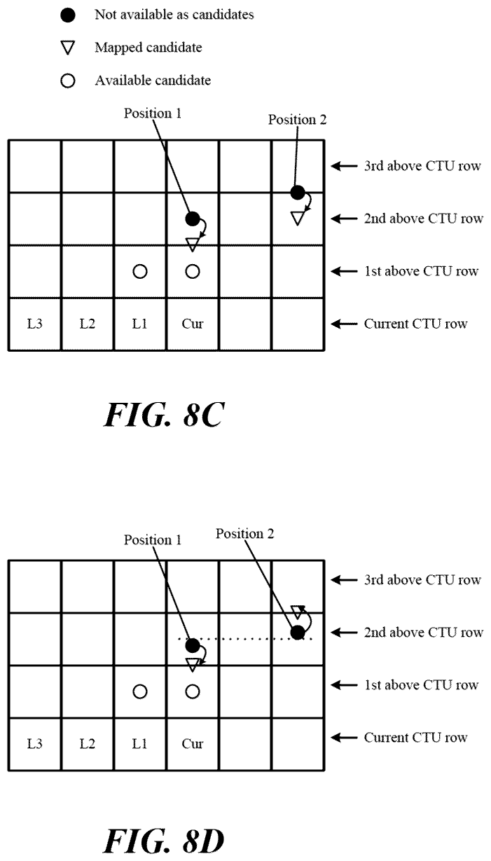

In some embodiments, the LIC information in current CTU row or current CTU row+M CTU rows (M≥0) can be referenced without limits. In some embodiments, for the to-be-referenced positions in the above CTU row (or the current CTU row+M CTU rows), the positions are mapped to a position at the bottom of a CTU row for referencing. This design can preserve most of the coding efficiency and does not require increased buffer size for storing LIC information of above CTU rows. FIG. 8A-D illustrate mapping non-adjacent spatial positions above the current CTU row for referencing LIC information. The LIC information in current CTU row or current CTU row+M CTU rows can be referenced without limits. FIGS. 8A-D show examples in which M=1, such that the LIC information in current CTU row and the first above CTU row can be referenced without limits. FIG. 8A shows an example in which, for to-be-referenced positions in above second, above third, above fourth CTU row, and so on, the positions are mapped to one line above the first CTU row.

In some embodiments, for the to-be-referenced positions in above CTU rows, the positions are mapped to the last line of that CTU row for referencing. FIG. 8B shows an example in which, when M=1, the LIC information in current CTU row and first CTU row above can be referenced without limits, and for the to-be-referenced positions in above second CTU row, the positions would be mapped to the bottom line of the second above CTU row. For the to-be-referenced positions in above third CTU row, the positions would be mapped to the bottom line of the third above CTU row, and so forth.

In some embodiments, for the to-be-referenced positions in an above CTU row, the positions would be mapped to the last line or bottom line or center line of that CTU row for referencing depended on the position of the to-be-referenced LIC information. For example, as illustrated in FIG. 8C, for a to-be-referenced position 1 in above second CTU row, the position is mapped to the bottom line of the second above CTU row. However, for a to-be-referenced position 2 in second above CTU row, the position is mapped to the center line of the second CTU row since it is closer to the center line compared with bottom line.

In some embodiments, for the to-be-referenced positions in an above CTU row, the positions would be mapped to the last line or bottom line of the that above CTU row for referencing dependent on the position of the to-be-referenced LIC information. For example, as shown in FIG. 8D, for the to-be-referenced position 1 in the second above CTU row, the positions would be mapped to the bottom line of the second above CTU row. However, for the to-be-referenced position 2 in the second above CTU row, the position is mapped to the bottom line of the third above CTU row since position 2 is closer to the bottom line of the third above CTU row compared with bottom line of the second above CTU row.

In some embodiments, the LIC information in current CTU/current CTU+N left CTU can be referenced without limits, and for the left CTUs, the to-be-referenced positions would be mapped to the very right line closed to current CTU/current CTU+N left CTU. For example, the LIC information in current CTU and first left CTU can be referenced without limits, and if the to-be-referenced positions are in second left CTU, the positions would be mapped to one line left to first left CTU. If the to-be-referenced positions are in third left CTU, the positions would be mapped to one line left to first left CTU. For example, the LIC information in current CTU and first left CTU can be referenced without limits, and if the to-be-referenced positions are in second left CTU, the positions would be mapped to the very right line of second left CTU. If the to-be-referenced positions are in third left CTU, the positions would be mapped to the very right line to third left CTU.

In some embodiments, when the available range for including non-adjacent candidates is constraint, if the position of a non-adjacent candidate is outside of the available range, that candidate is skipped and will not be inserted into the candidate list. The available region could be the current CTU, current CTU row, current CTU row+above N CTU rows, current CTU+left M CTUs, or current CTU+above N CTU rows+left M CTUs.

j. Constructing a Candidate List

In some embodiments, the candidate list is constructed by adding candidates in a pre-defined order until the maximum candidate number is reached. The candidates added may include all or some of the forementioned candidates, but not limited to the forementioned candidates. For example, the candidate list could include spatial neighboring candidates, temporal neighboring candidate, historical candidates, non-adjacent neighboring candidates, single model candidates generated based on other inherited models. For another example, the candidate list could include the same candidates as previous example, but the candidates are added into the list in different order.

In some embodiments, the candidates associated with propagated LIC information (described in Section III.n) are inserted after the candidates associated with non-propagated LIC information.

In some embodiments, if all the pre-defined neighboring and historical candidates are added but the maximum candidate number is not reached, some default candidates are added into the candidate list until the maximum candidate number is reached. In some embodiment, a default candidate may be a shortcut to indicate an LIC mode (i.e., uses the current neighboring reconstruction samples to derive LIC models) rather than inheriting parameters from neighbors. For example, default candidate could be LIC_LT, LIC_L, LIC_T.

In some embodiments, a default candidate may be the first model of an earlier multi-model LIC candidate (i.e., the model used when the sample value is less than or equal to classification threshold). In some embodiments, a default candidate may be the second model of an earlier multi-model LIC candidate (i.e., the model used when the sample value is greater than or equal to classification threshold). In some embodiments, a default candidate may be the combination of two models of an earlier multi-model LIC candidate. For example, if the models of an earlier multi-model LIC candidate are

$$\{ {c}_{0}^{0} , {c}_{1}^{0} , … , {c}_{M - 1}^{0} \} and \{ {c}_{0}^{1} , {c}_{1}^{1} , … , {c}_{M - 1}^{1} \} .$$

The model parameters of an default candidate could be

$$\{ ( 1 - α ) \times {c}_{0}^{0} + α \times {c}_{0}^{1} , ( 1 - α ) \times {c}_{1}^{0} + α \times {c}_{1}^{1} , … , ( 1 - α ) \times {c}_{M - 1}^{0} + α \times {c}_{M - 1}^{1} \} ,$$

where α is a weighting factor which could be predefined or implicitly derived by neighboring template cost, and

$${c}_{x}^{y}$$

is the x-th parameter of the y-th model.

In some embodiments, default candidates may be derived from reconstructed samples from non-adjacent neighboring regions. Let the current block position be at (x, y) and the block size be w×h. If the reconstructed samples in the M×N region located at (x+dx, y+dy) are “available”, the default candidates can be derived using reconstructed samples in the region. For example, M×N could be 8×8. For another example, M×N could be 16×8. For another example, M×N could be 16×16. For another example, M×N may be w×h. The meaning of “available” can be the reconstructed sample inside the current block is available, or the reconstructed sample inside the k lines of neighboring samples is available.

In some embodiments, default candidates derived from reconstructed samples from non-adjacent neighboring regions may be any type of LIC model or some particular types of LIC model. For example, the derived model may be LIC, multi-model LIC. For another example, the derived model is LIC model.

In some embodiments, when constructing a candidate list, candidates are included into the list according to a pre-defined order. For example, the pre-defined order could be spatial adjacent candidates, temporal candidates, spatial non-adjacent candidates, historical candidates, and then default candidates.

When constructing a candidate list, the video coder may allow only the candidate with a certain prediction mode to be added into the list. For example, the video coder may allow only the candidates derived by LIC or multi-model LIC modes be added into the list. For another example, the video coder may allow only the candidates derived by single-model modes to be added into the list. For another example, the video coder may allow only the candidates derived by multi-model modes to be added into the list. In some embodiments, if only the candidate of a certain prediction mode can be added into the list, the video coder may signal the prediction mode first and then signal whether LIC merge mode is used or not. If LIC merge mode is used, then the candidate index is signaled.

k. Reordering the Candidates in the Candidate List

In some embodiments, the candidates in the candidate list may be reordered to reduce the syntax overhead when signaling the selected candidate index. The reordering rules may depend on the coding information of neighboring blocks or the model error. For example, if neighboring above or left blocks are coded by LIC and using a target LIC mode, the candidates in the lists have the target LIC mode can be moved to the head of the current list.

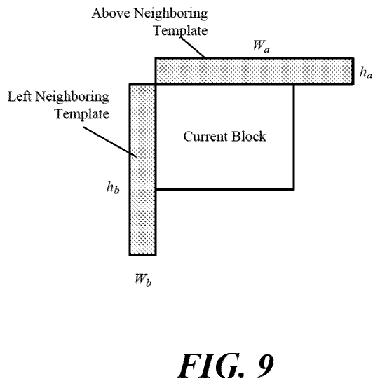

In some embodiments, the reordering rule is based on the model error by applying the candidate model to the neighboring templates of the current block, and then compare the error with the reconstruction samples of the neighboring template. For example, as shown in the FIG. 9 which illustrates neighboring templates used for calculating LIC model error., the size of above neighboring template of the current block is wₐ×hₐ, and the size of left neighboring template of the current block is wₚ×hₚ. Suppose K models are in the current candidate list, and αₖ and βₖ are the final scale and offset parameters after inheriting the candidate k. The model error of candidate k by the above neighboring template is:

$${e}_{a}^{k} = {\sum }_{i , j} \vert ( {a}_{k} \times {recL}_{a}^{′ ( i , j )} + {β}_{k} ) - {recL}_{a}^{( i , j )} \vert$$

where,

$$r e c {L}_{a}^{′ ( i , j )} and {recL}_{a}^{( i , j )}$$

are the corresponding referenced luma samples of the previous coded frame and the reconstructed luma samples of the current frame at position (i, j) in the above template, and 0≤i<wₐ and 0≤j<hₐ. Similarly, the model error of candidate k by the left neighboring template is:

$${e}_{b}^{k} = {\sum }_{m , n} \vert ( {a}_{k} \times {recL}_{b}^{′ ( m , n )} + {β}_{k} ) - {recL}_{b}^{( m , n )} \vert$$

where

$${recL}_{b}^{′ ( m , n )} and {recL}_{b}^{( m , n )}$$

are the corresponding referenced luma samples of the previous coded frame and the reconstructed luma samples of the current frame at position (m, n) in the left template, and 0≤m<w_{b} and 0≤n<h_{b}. In some embodiments, if the current block is coded by bi-directional prediction, the model error of candidate k by the above neighboring template is:

$${e}_{a}^{k} = {\sum }_{i , j} \vert ( {a}_{k} \times ( {f}_{0} \times r e c L {0}_{a}^{′ ( i , j )} + {f}_{1} \times r e c L {1}_{a}^{′ ( i , j )} ) + {β}_{k} ) - r e c {L}_{a}^{′ ( i , j )} \vert$$

where,

$$r e c L {0}_{a}^{′ ( i , j )} , r e c L {1}_{a}^{′ ( i , j )} and {recL}_{a}^{( i , j )}$$

are the corresponding referenced luma samples of the previous coded frame in List 0 and List 1 and the reconstructed luma samples of the current frame at position (i, j) in the above template, 0≤i<wₐ and 0≤j<hₐ, and f₀ and f₁ are the blending weight of bi-directional prediction. Similarly, the model error of candidate k by the left neighboring template is:

$${e}_{b}^{k} = {\sum }_{m , n} \vert ( {a}_{k} \times ( {f}_{0} \times r e c L {0}_{b}^{′ ( m , n )} + {f}_{1} \times r e c L {1}_{b}^{′ ( m , n )} ) + {β}_{k} ) - r e c {L}_{b}^{( m , n )} \vert$$

where

$$r e c L {0}_{b}^{′ ( m , n )} , r e c L {1}_{b}^{′ ( m , n )} and {recL}_{b}^{( m , n )}$$

are the corresponding referenced luma samples of the previous coded frame in List 0 and List 1 and the reconstructed luma samples of the current frame at position (m, n) in the left template, and 0≤m<wₚ and 0≤n<h_{b}, and f₀ and f₁ are the blending weight of bi-directional prediction. Then the model error of candidate k is:

$${e}^{k} = {e}_{a}^{k} + {e}_{b}^{k}$$

After calculating the model error among all candidates, the video coder may compile a model error list E={e⁰, e¹, e², . . . , e^{k}, . . . , e^{K}}. The video coder may reorder the candidate index in the inherit candidate list by sorting the model error list in ascending order.

In some embodiments, if the candidate k uses convolutional model, the model error,

$${e}_{a}^{k} and {e}_{b}^{k} ,$$

are defined as

$${e}_{a}^{k} = {\sum }_{i , j} \vert ( c {0}_{k} \times r e c {L}_{a}^{′ ( i , j )} + c {1}_{k} \times r e c {L}_{a}^{′ ( i , j - 1 )} + c {2}_{k} \times r e c {L}_{a}^{′ ( i , j + 1 )} + c {3}_{k} \times rec {L}_{a}^{′ ( i - 1 , j )} + c {4}_{k} \times r e c {L}_{a}^{′ ( i + 1 , j )} + c {5}_{k} \times P + c {6}_{k} \times B ) - r e c {L}_{a}^{( i , j )} \vert$$

$${e}_{b}^{k} = {\sum }_{i , j} \vert ( c {0}_{k} \times r e c {L}_{b}^{′ ( i , j )} + c {1}_{k} \times r e c {L}_{b}^{′ ( i , j - 1 )} + c {2}_{k} \times r e c {L}_{b}^{′ ( i , j + 1 )} + c {3}_{k} \times rec {L}_{b}^{′ ( i - 1 , j )} + c {4}_{k} \times r e c {L}_{b}^{′ ( i + 1 , j )} + c {5}_{k} \times P + c {6}_{k} \times B ) - r e c {L}_{b}^{( i , j )} \vert$$

where c0ₖ, c1ₖ, c2ₖ, c3ₖ, c4ₖ, c5ₖ, and c6ₖ are the final filtering coefficients after inheriting the candidate k. P and B are the nonlinear term and bias term. In some embodiments, if the current block is coded by bi-directional prediction and the candidate k uses convolutional model, the model error,

$${e}_{a}^{k} and {e}_{b}^{k} ,$$

are defined as

$${e}_{a}^{k} = {\sum }_{i , j} \vert ( c {0}_{k} \times ( {f}_{0} \times r e c L {0}_{a}^{′ ( i , j )} + {f}_{1} \times r e c L {1}_{a}^{′ ( i , j )} ) + c {1}_{k} \times ( {f}_{0} \times recL {0}_{a}^{′ ( i , j - 1 )} + {f}_{1} \times r e c L {1}_{a}^{′ ( i , j - 1 )} ) + c {2}_{k} \times ( {f}_{0} \times r e c L {0}_{a}^{′ ( i , j + 1 )} + {f}_{1} \times r e c L {1}_{a}^{′ ( i , j + 1 )} ) + c {3}_{k} \times ( {f}_{0} \times r e c L {0}_{a}^{′ ( i - 1 , j )} + {f}_{1} \times r e c L {1}_{a}^{′ ( i - 1 , j )} ) + c {4}_{k} \times ( {f}_{0} \times r e c L {0}_{a}^{′ ( i + 1 , j )} + {f}_{1} \times r e c L {1}_{a}^{′ ( i + 1 , j )} ) + c {5}_{k} \times P + c {6}_{k} \times B ) - r e c {L}_{a}^{( i , j )} \vert$$

$${e}_{b}^{k} = {\sum }_{m , nj} \vert ( c {0}_{k} \times ( {f}_{0} \times r e c L {0}_{b}^{′ ( m , n )} + {f}_{1} \times r e c L {1}_{b}^{′ ( m , n )} ) + c {1}_{k} \times ( {f}_{0} \times recL {0}_{b}^{′ ( m , nj - 1 )} + {f}_{1} \times r e c L {1}_{b}^{′ ( m , n - 1 )} ) + c {2}_{k} \times ( {f}_{0} \times r e c L {0}_{b}^{′ ( m , n + 1 )} + {f}_{1} \times recL {1}_{b}^{′ ( m , nj + 1 )} ) + c {3}_{k} \times ( {f}_{0} \times r e c L {0}_{b}^{′ ( m - 1 , n )} + {f}_{1} \times r e c L {1}_{b}^{′ ( m - 1 , n )} ) + c {4}_{k} \times ( {f}_{0} \times r e c L {0}_{b}^{′ ( m + 1 , n )} + {f}_{1} \times r e c L {1}_{b}^{′ ( m + 1 , n )} ) + c {5}_{k} \times P + c {6}_{k} \times B ) - r e c {L}_{b}^{( m , n )} \vert$$

where c0ₖ, c1ₖ, c2ₖ, c3ₖ, c4ₖ, c5ₖ, and c6ₖ are the final filtering coefficients after inheriting the candidate k. P and B are the nonlinear term and bias term. In some embodiments, if the above neighboring template is not available, then

$${e}^{k} = {e}_{b}^{k} .$$

Similarly, if the left neighboring template is not available, then

$${e}^{k} = {e}_{a}^{k} .$$

If both templates are not available, the candidate index reordering method using model error is not applied.

In some embodiments, not all positions inside the above and left neighboring template are used in calculating model error. The video coder may choose partial positions inside the above and left neighboring template to calculate model error. For example, the video coder may define a first start position and a first subsampling interval depending on the width of the current block to partially select positions inside the above neighboring template. Similarly, the video coder may define a second start position and a second subsampling interval depends on the height of the current block to partially select positions inside the left neighboring template. For another example, hₐ or w_{b} could be a constant value (e.g., hₐ or w_{b} could be 1, 2, 3, 4, 5, or 6). For another example, hₐ or w_{b} may depend on block size. If the current block size is greater than or equal to a threshold, hₐ or w_{b} is equal to a first value. Otherwise, hₐ or w_{b} is equal to a second value.

m. Signaling the Candidate Selection from the List

In some embodiments, an on/off flag is signaled to indicate whether the current block inherits the LIC model information from neighboring blocks or not. The flag can be signaled per CU/CB, per PU, per TU/TB, or per color component. A high-level syntax may be signaled in SPS, PPS, PH or SH to indicate if the proposed method is allowed for the current sequence, picture, or slice.

In some embodiments, the LIC model inheritance on/off flag may have multiple context model, and the selection of multiple context models may depend on the block size, number of neighboring inter coded block, number of neighboring LIC coded block, or number of neighboring inherited LIC coded block.

In some embodiments, the maximum allowed candidate number is signaled to indicate the maximum size of the merge candidate list. The number can be signaled per CU/CB, per PU, per TU/TB, or per color component. A high-level syntax may be signaled in SPS, PPS, PH or SH to indicate the maximum allowed candidate number for the current sequence, picture, or slice. In some embodiments, the maximum allowed candidate number may be shared with the maximum allowed candidate number for inter merge mode.

In some embodiments, if the current block inherits the LIC model parameters from neighboring blocks, the inherit candidate index is signaled. The index may be signaled (e.g., signaled using truncate unary code, Exp-Golomb code, or fix length code) for each color component. For another example, the index of chroma component could be signaled and shared among Cb and Cr blocks. In some embodiments, the candidate index is implicitly derived as the first candidate in the candidate list. In some embodiments, the candidate index is implicitly derived as the first candidate in the candidate list after list reordering as described in Section III.k above.

n. Propagated LIC Information

In some embodiments, after encoding or decoding a block, the LIC information of the current block is derived and stored in the current block. The stored LIC information can be referenced by the following coding blocks. The following coding blocks could inherit LIC information from the current block. The definition of LIC information is in Section III.a. The stored LIC information could be inherited as but not limited to the following types of candidates: spatial candidates (as in Section III.c), non-adjacent candidates (as in Section III.e), temporal candidates (as in Section III.d), historical candidates (as in Section III.f).

In some embodiments, if the current block does not have native LIC information (e.g., the block is intra coded) and there are block vectors available in the current block, (e.g., the current luma block is coded in IBC or IntraTMP mode, the collocated luma block is coded in IBC or IntraTMP mode), the LIC information of the current block could be derived by copying the LIC information of the reference block located by the block vector. For example, as shown in the following figure, block B does not have LIC information and there are block vectors available at block B. The reference block A is located by the block vector. The LIC information of the reference block A is copied and stored in block B. In some embodiments, if the reference block located by the block vector also does not have native LIC information, but there is LIC information stored in the reference block, the LIC information of the current block could be derived by copying the LIC information stored in the reference block. That is, as long as the reference block has valid stored LIC information, the stored LIC information can be referenced by the current block. For example, as shown in the following figure, the current block C has block vector available, and its reference block B has LIC information stored. The LIC information of block B is copied and stored in block C. Since the LIC information stored in block B was copied from block A, the LIC information stored in block C is originally from block A (i.e., the LIC information of block A is propagated to block C). By only accessing block B, block C can retrieve LIC information from originally from block A. In some embodiments, if the reference block located by the block vector does not have LIC information stored, no LIC information is stored for the current block.

In some embodiments, when the current block has multiple block vectors available (e.g., the block vector could be bi-directional, the block could have multiple IntraTMP block vectors, or the current chroma block is collocated with multiple luma blocks and more than one of the luma blocks have block vectors), to derive the LIC information of the current block, if only one of the reference blocks located by the block vectors has LIC information, the LIC information from the reference block which has LIC information is copied to and stored in the current block. For example, as shown in the following figure, suppose block F has two block vectors and has two reference blocks G and H. Block G has LIC information and block H does not. The LIC information of block G is copied to and stored in block F.

In some embodiments, when the current block has multiple block vectors, and more than one of the reference blocks located by the block vectors has LIC information, one of the reference blocks is selected based on a set of pre-defined rules. The LIC information of the selected reference block is then copied and stored in the current block.

In some embodiments, the reference block associated with native LIC information is selected (i.e., the LIC information is not copied from a reference block).

In some embodiments, the reference block whose distance to the current block is the smallest is selected. The LIC information of the selected reference block is copied to and stored in the current block. The distance between the reference block and the current block, located at (xr, yr) and (xc, yc) respectively, could be computed by d=\sqrt{(xᵣ−x_{c})²+(yᵣ−y_{c})²}. (x, yr) and (xc, yc) could be the top-left, top-right, bottom-left, bottom-right, or center positions of the reference block and the current block.

In some embodiments, the reference block which has the smallest horizontal distance, |xr−xc|, is selected. The LIC information of the selected reference block is copied to and stored in the current block.

In some embodiments, the reference block which has the smallest vertical distance, |yr−yc|, is selected. The LIC information of the selected reference block is copied to and stored in in the current block.

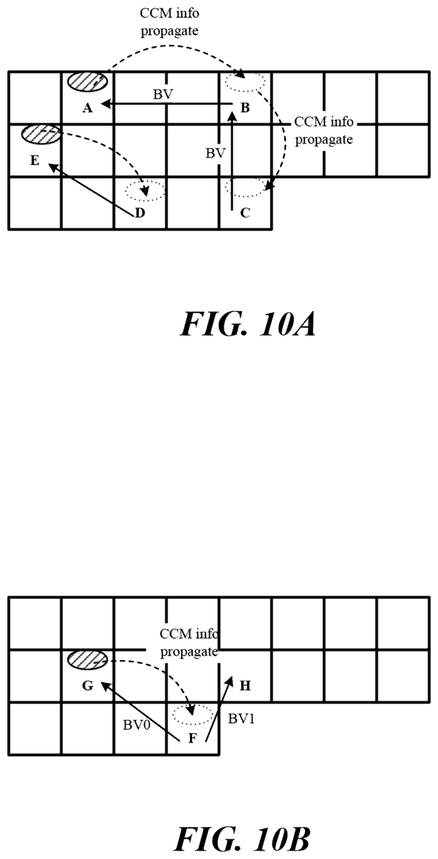

In some embodiments, the rules described previously could be combined, and not all the rules described previously need to be applied. For example, the reference block associated with native LIC information is selected. If there are more than one reference blocks associated with native LIC information, then the block which has the shortest distance to the current block is selected. If there are more than one reference blocks associated with native LIC information whose distances to the current block are the smallest, the reference block which has the smallest horizontal distance, |xr−xc|, is selected. The LIC information of the selected reference block is copied to and stored in the current block. FIGS. 10A-B illustrate examples of LIC information propagation based on block vectors reference blocks in the current picture. The blocks with dash line (i.e., A, E, G) are associated with native LIC information.

In some embodiments, if the current block does not have native LIC information and there are motion vectors available in the current block (e.g. the current luma block is inter-coded), the LIC information of the current block could be derived by copying the LIC information of its reference block in a reference picture, located by the motion vectors of the current block. For example, as shown in the following figure, block B does not have native LIC information and there are motion vectors available at block B. The reference block A is located by the motion vector. The LIC information of the reference block A is copied and stored in block B. In some embodiments, if the reference block located by the motion vector also does not have native LIC information but there is LIC information stored in the reference block, the LIC information of the current block could be derived by copying the LIC information stored in the reference block. That is, as long as the reference block has valid stored LIC information, the stored LIC information can be referenced by the current block. For example, as shown in the following figure, the current block C has motion vector available, and its reference block B has LIC information stored. The LIC information of block B is copied and stored in block C. Since the LIC information stored in block B was copied from block A, the LIC information stored in block C is originally from block A (i.e., the LIC information of block A is propagated to block C). By only accessing block B, block C can retrieve LIC information from originally from block A. In some embodiments, if the reference block located by the motion vector does not have LIC information stored, no LIC information is stored for the current block.

In some embodiments, the motion vectors used to derive the reference block is the motion vectors at the center of the current block. In some embodiments, the motion vectors used to derive the reference block is the motion vectors at the top-left corner of the current block. In some embodiments, the motion vectors used to derive the reference block is the MVP (motion vector predictor) of the current block. In some embodiments, the motion vectors used to derive the reference block is the combination of MVP and MVD of the current block.

In some embodiments, when the current block is inter-coded with bi-directional prediction, to derive the LIC information of the current block, if only one of the reference blocks located by the motion vectors has LIC information, the LIC information from the reference block which has LIC information is copied to and stored in the current block. For example, as shown in the following figure, suppose block F is inter-coded with bi-directional prediction. The two reference blocks located by the motion vectors are block G and block H. Block G has stored LIC information and block H does not. The LIC information of block G is copied to and stored in block F.

In some embodiments, when the current block is inter-coded with bi-directional prediction, and both reference blocks located by the motion vectors has stored LIC information, one of the reference blocks is selected based on a set of pre-defined rules. The LIC information of the selected reference block is then copied and stored in the current block. In some embodiments, the reference block associated with native LIC information is selected.

In some embodiments, the reference block whose reference picture has the smaller POC distance to the current picture is selected. The LIC information of the selected reference block is copied to and stored in the current block. As shown in the following figure, block F is inter-coded with bi-directional prediction. The two reference blocks located by the motion vectors are block G and block H. Assume block G and block H both have stored LIC information, and |N1−N2| is smaller than |N3−N2|. Then block G is selected, and the LIC information of block G is copied to and stored in block F.

In some embodiments, the reference block whose reference picture has the smaller QP difference from the current picture is selected. The LIC information of the selected reference block is copied to and stored in the current block. As shown in the following figure, block F is inter-coded with bi-directional prediction. The two reference blocks located by the motion vectors are block G and block H. Assume block G and block H both have stored LIC information. Assume the QPs of the pictures of POC N1, POC N2 and POC N3 are 27, 32, 33 respectively. Since |33−32| is smaller than |27−32|, block H is selected, and the LIC information of block H is copied to and stored in block F. In some embodiments, the reference block whose reference picture has the smaller QP value is selected. In some embodiments, the reference block whose reference picture has the larger QP values is selected.

In some embodiments, the LIC information of both reference blocks are applied on the samples of the template of the current block to generate the prediction samples of the template. The distortion between the prediction and the reconstructed samples of the template computed. The reference block associated with the smaller distortion is selected.

In some embodiments, the rules described previously could be combined, and not all the rules described previously need to be applied. For example, the reference block associated with native LIC information is selected. If both blocks are associated with native LIC information, then the block whose reference picture has the smaller POC distance to the current picture is selected. If both blocks are associated with native LIC information and has the same POC distance to the current picture, the reference block whose reference picture has the smaller QP difference from the current picture is selected. If both blocks are associated with native LIC information, has the same POC distance to the current picture, and has the same QP difference from the current picture, then the reference block whose reference picture has the smaller QP value is selected. For another example, the block whose reference picture has the smaller POC distance to the current picture is selected. If both blocks have the same POC distance to the current picture, the reference block whose reference picture has the smaller QP difference from the current picture is selected. If both blocks have the same POC distance to the current picture and have the same QP difference from the current picture, then the reference block whose reference picture has the smaller QP value is selected.

In some embodiments, when the reference picture located by the motion vector is rescaled, i.e., the RprConstraintsActiveFlag of the reference picture is true, which means the reference picture has one or more of the following seven parameters different than that of the current picture: 1) the picture width in luma samples (pps_pic_width_in_luma_samples), 2) the picture height in luma samples (pps_pic_height_in_luma_samples), 3) the scaling window left offset (pps_scaling_win_left_offset), 4) the scaling window right offset (pps_scaling_win_right_offset), 5) the scaling window top offset (pps_scaling_win_top_offset), 6) the scaling window botton offset (pps_scaling_win_bottom_offset), and 7) the number of sub pictures−1 (sps_num_subpics_minus1), it is considered as no LIC information could be located by this motion vector. Thus, no LIC information is retrieved and stored.

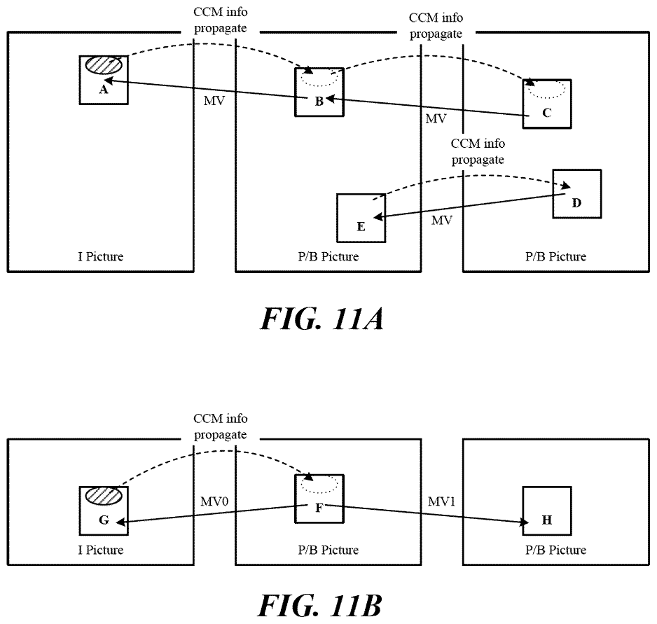

In some embodiments, when the reference picture located by the motion vector is rescaled, the position of the reference block could be scaled according to the scaling ratio. The scaling ratio is derived based on the scaling window of the current picture and the collocated picture. Let the position of the reference block be (x, y), the scaled position of the reference block be (x′, y′) and the scaling ratio be R. The scaled position could be (x/R, y/R) or (x/R, y/R) after rounding. The rounding method used could be but not limited to the following methods: rounding toward negative infinity, rounding toward positive infinity, rounding toward zero, or rounding to the nearest integer (e.g., rounding away from zero, rounding half up, rounding half down, . . . ). FIGS. 11A-B illustrate examples LIC information propagation based on motion vectors referencing blocks in reference pictures. In the figure, the blocks with dash line (i.e., A, E, G) are associated with native LIC information.

In some embodiments, if the POC distance between the reference picture located by the motion vector and the current picture is greater than a pre-defined threshold, the motion vector and the reference block is considered unavailable. In some embodiments, if the current block is inter-coded or there's block vector available in the current block, the LIC information of the current block could be derived by copying the LIC information of the reference block located by the motion vector or the block vector.

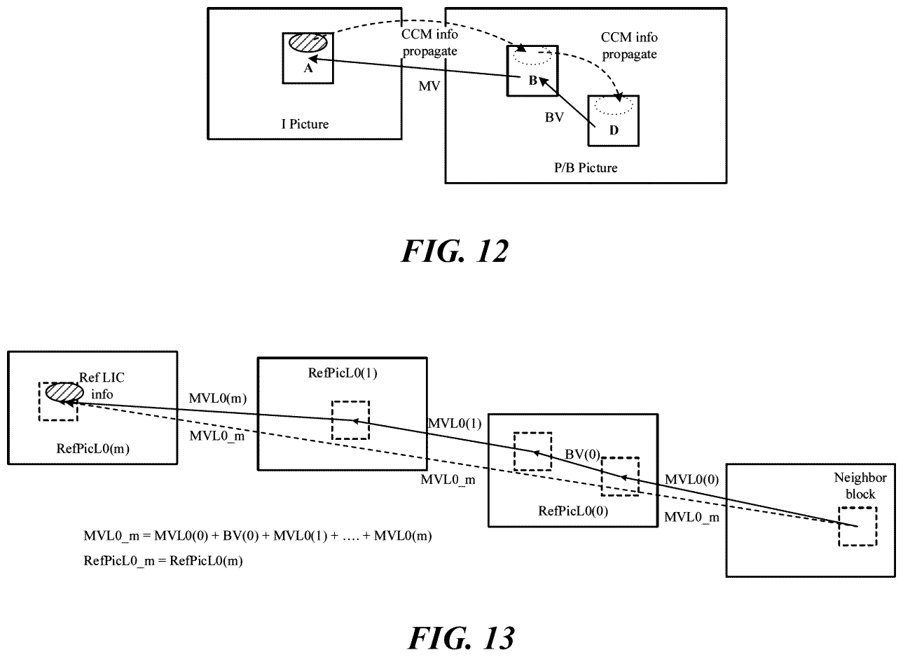

FIG. 12 illustrates propagating LIC information based on both block vector and motion vector. For example, as shown in the following figure, the current block C has block vector available, and its referenced block B has motion vector available. The LIC information of block B is coped from block A. The LIC information of block B is then copied to block C. Hence the LIC information of block A is propagated to the current block C.

In some embodiments, if the current slice/picture is a non-intra slice/picture, the LIC information of the current block could be derived by copying the LIC information of its collocated block in a collocated picture. The definition of collocated picture can be found in the as in Section III.d.

In some embodiments, if the POC distance between the collocated picture and the current picture is greater than a pre-defined threshold, copying and storing the LIC information from the collocated picture will not be performed.

In some embodiments, the LIC information derivation process is performed after the encoding/decoding of the current picture.

In some embodiments, when multiple types of propagated LIC information are available for the current block, the propagated LIC information to be stored in the current block is determined based on a set of pre-defined rules. For example, if both the reference block located by the motion vectors and the reference block which is the current block's collocated block in the collocated picture have valid LIC information, the LIC information of the reference block located by the motion vectors is copied and stored in the current block. For another example, the LIC information of the collocated block is copied and stored in the current block. For another example, the LIC information of the reference block located by the motion vectors is copied and stored in the current block after encoding/decoding a block. After encoding/decoding a picture, the LIC information of the collocated block is copied and stored in the current block (i.e., the LIC information of the reference block located by the motion vectors is replaced).

For example, if both the reference block located by the block vectors and the reference block which is the current block's collocated block in the collocated picture have valid LIC information, the LIC information of the reference block located by the block vectors is copied and stored in the current block. For another example, the LIC information of the collocated block is copied and stored in the current block. For another example, the LIC information of the reference block located by the block vectors is copied and stored in the current block after encoding/decoding a block. After encoding/decoding a picture, the LIC information of the collocated block is copied and stored in the current block (i.e., the LIC information of the reference block located by the block vectors is replaced).

o. Cascaded Vector LIC Information

In some embodiments, when referencing the LIC information from neighboring blocks, if the neighboring block has motion vector or block vector available, cascaded vectors can be derived based the motion vector or the block vector of the neighboring block. LIC information of the blocks indicated by the cascaded vectors can also be inherited. The definition of LIC information is in Section III.a. The neighboring blocks can be but not limited to the following types of candidates: spatial candidates (as in Section III.c), non-adjacent candidates (as in Section III.e), temporal candidates (as in Section III.d), historical candidates (as in Section III.f).

FIG. 13 illustrates cascading motion vectors and block vectors. As illustrated, a cascaded vector can be derived as the sum of the recursively traced motion vectors and/or block vectors based on the motion vector or the block vector of a neighboring block. For example, a cascade vector can be derived as following: Let the L0 motion vector of the neighbor block be MVL0(0), the block vector of the block indicated by MVL0(0) is BV(0), the L0 motion vector of the block indicated by BV(0) is MVL0(1) and so on. The cascaded vector MV_m is: MV_m=MVL0(0)+BV(0)+MVL0(1)+ . . . +MVL0(m). And the reference picture of MVL0_m is: RefPicL0_m=RefPicL0(m). Here m is the trace depth, that is the number of reference picture referenced back. Cascaded vectors can be the sum of L0 motion vectors, L1 motion vectors and block vectors.

For each recursion, multiple cascaded vectors can be derived if the based block has multiple motion vectors or multiple block vectors. For example, assume the block indicated by MVL0(1) is bi-prediction and has two motion vector MVL0(2) and MVL1(2). Two cascaded vectors can be derived as MV_1+MVL0(2) and MV_1+MVL1(2), where MV_1=MVL0(0)+BV(0)+MVL0(1).

The trace depth m can be a finite value, for example, m=1. The trace depth m can also be infinite. The trace depth m can be pre-defined. A set of cascaded vectors can be derived for different m. The neighboring block can be a CU/CB, PU, TU/TB or a corresponding block with the same size of the current block.

p. Multiple Vector-Propagated LIC Information

As described in Section III.n, after encoding or decoding a block, the LIC information of the current block is derived and stored in the current block. In some embodiments, more than one LIC information can be stored in the current block.

In some embodiments, if the current block has motion vector or block vector available and the current block has native LIC information, in addition to storing the LIC information used by the current block, the LIC information of the reference block located by the cascaded vector, as described in Section III.o can also be stored in the current block for future referencing. If the current block does not have native LIC information, the LIC information of the reference block located by the cascaded vector, as described in Section III.o can also be stored in the current block for future referencing.

The maximum number of LIC information allowed to be stored in one block can be pre-defined. If the available number of LIC information exceeds the maximum allowed number, the priority of the LIC information to be stored can be defined. For example, if the current block has native LIC information, the current native LIC information has the highest priority. For another example, the priority can be determined based on the trace depth of the cascaded vector. The shorter the trace depth is, the higher the priority is for the LIC information. The above rules can be combined.

Any of the foregoing proposed methods could be applied independently or jointly. Moreover, any of the foregoing proposed methods can be implemented in encoders and/or decoders. For example, any of the proposed methods can be implemented in inter prediction module of an encoder and/or a decoder. Alternatively, any of the proposed methods can be implemented as a circuit coupled to inter prediction module of the encoder and/or the decoder.

### IV. Example Video Encoder

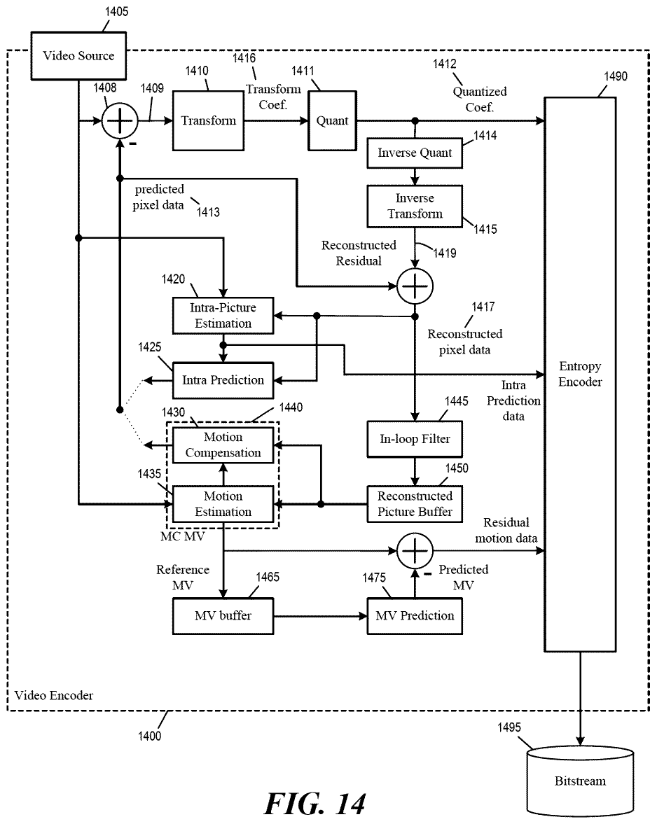

FIG. 14 illustrates an example video encoder 1400 that may implement LIC. As illustrated, the video encoder 1400 receives input video signal from a video source 1405 and encodes the signal into bitstream 1495. The video encoder 1400 has several components or modules for encoding the signal from the video source 1405, at least including some components selected from a transform module 1410, a quantization module 1411, an inverse quantization module 1414, an inverse transform module 1415, an intra-picture estimation module 1420, an intra-prediction module 1425, a motion compensation module 1430, a motion estimation module 1435, an in-loop filter 1445, a reconstructed picture buffer 1450, a MV buffer 1465, and a MV prediction module 1475, and an entropy encoder 1490. The motion compensation module 1430 and the motion estimation module 1435 are part of an inter-prediction module 1440.

In some embodiments, the modules 1410-1490 are modules of software instructions being executed by one or more processing units (e.g., a processor) of a computing device or electronic apparatus. In some embodiments, the modules 1410-1490 are modules of hardware circuits implemented by one or more integrated circuits (ICs) of an electronic apparatus. Though the modules 1410-1490 are illustrated as being separate modules, some of the modules can be combined into a single module.

The video source 1405 provides a raw video signal that presents pixel data of each video frame without compression. A subtractor 1408 computes the difference between the raw video pixel data of the video source 1405 and the predicted pixel data 1413 from the motion compensation module 1430 or intra-prediction module 1425 as prediction residual 1409. The transform module 1410 converts the difference (or the residual pixel data or residual signal 1409) into transform coefficients (e.g., by performing Discrete Cosine Transform, or DCT). The quantization module 1411 quantizes the transform coefficients into quantized data (or quantized coefficients) 1412, which is encoded into the bitstream 1495 by the entropy encoder 1490.

The inverse quantization module 1414 de-quantizes the quantized data (or quantized coefficients) 1412 to obtain transform coefficients, and the inverse transform module 1415 performs inverse transform on the transform coefficients to produce reconstructed residual 1419. The reconstructed residual 1419 is added with the predicted pixel data 1413 to produce reconstructed pixel data 1417. In some embodiments, the reconstructed pixel data 1417 is temporarily stored in a line buffer (not illustrated) for intra-picture prediction and spatial MV prediction. The reconstructed pixels are filtered by the in-loop filter 1445 and stored in the reconstructed picture buffer 1450. In some embodiments, the reconstructed picture buffer 1450 is a storage external to the video encoder 1400. In some embodiments, the reconstructed picture buffer 1450 is a storage internal to the video encoder 1400.

The intra-picture estimation module 1420 performs intra-prediction based on the reconstructed pixel data 1417 to produce intra prediction data. The intra-prediction data is provided to the entropy encoder 1490 to be encoded into bitstream 1495. The intra-prediction data is also used by the intra-prediction module 1425 to produce the predicted pixel data 1413.

The motion estimation module 1435 performs inter-prediction by producing MVs to reference pixel data of previously decoded frames stored in the reconstructed picture buffer 1450. These MVs are provided to the motion compensation module 1430 to produce predicted pixel data.

Instead of encoding the complete actual MVs in the bitstream, the video encoder 1400 uses MV prediction to generate predicted MVs, and the difference between the MVs used for motion compensation and the predicted MVs is encoded as residual motion data and stored in the bitstream 1495.

The MV prediction module 1475 generates the predicted MVs based on reference MVs that were generated for encoding previously video frames, i.e., the motion compensation MVs that were used to perform motion compensation. The MV prediction module 1475 retrieves reference MVs from previous video frames from the MV buffer 1465. The video encoder 1400 stores the MVs generated for the current video frame in the MV buffer 1465 as reference MVs for generating predicted MVs.

The MV prediction module 1475 uses the reference MVs to create the predicted MVs. The predicted MVs can be computed by spatial MV prediction or temporal MV prediction. The difference between the predicted MVs and the motion compensation MVs (MC MVs) of the current frame (residual motion data) are encoded into the bitstream 1495 by the entropy encoder 1490.

The entropy encoder 1490 encodes various parameters and data into the bitstream 1495 by using entropy-coding techniques such as context-adaptive binary arithmetic coding (CABAC) or Huffman encoding. The entropy encoder 1490 encodes various header elements, flags, along with the quantized transform coefficients 1412, and the residual motion data as syntax elements into the bitstream 1495. The bitstream 1495 is in turn stored in a storage device or transmitted to a decoder over a communications medium such as a network.

The in-loop filter 1445 performs filtering or smoothing operations on the reconstructed pixel data 1417 to reduce the artifacts of coding, particularly at boundaries of pixel blocks. In some embodiments, the filtering or smoothing operations performed by the in-loop filter 1445 include deblock filter (DBF), sample adaptive offset (SAO), and/or adaptive loop filter (ALF). In some embodiments, luma mapping chroma scaling (LMCS) is performed before the loop filters.

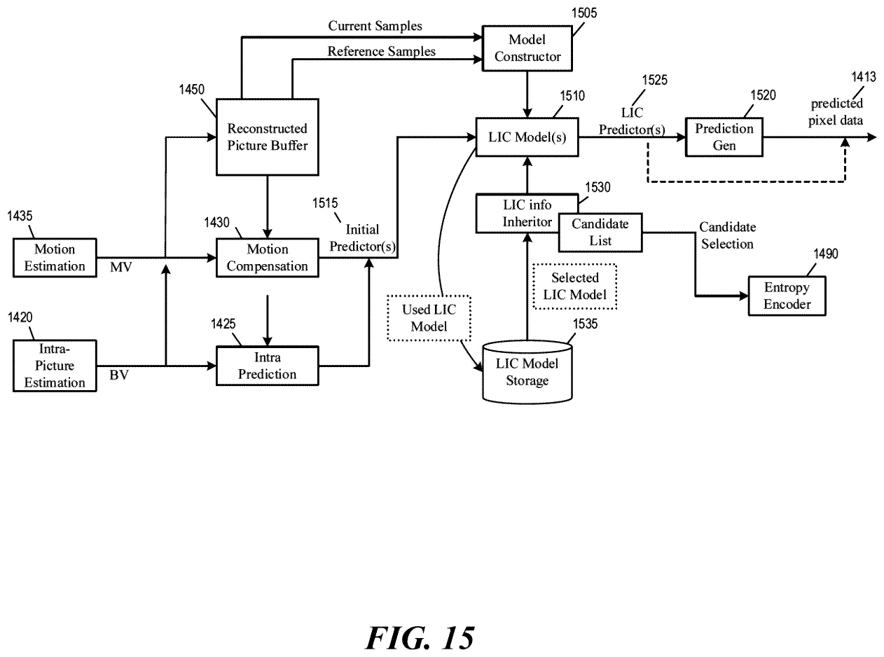

FIG. 15 illustrates portions of the video encoder 1400 that implement inheriting LIC information. The current block may be initially coded by inter-prediction or intra-prediction (motion compensation module 1430 or intra prediction module 1425), which generates an initial predictor 1515. When the current block is coded by inter-prediction, the initial predictor 1515 may be a reference block in a reference picture identified by a motion vector (MV). When the current block is coded by bidirectional inter-prediction, the initial predictor 1515 may include two reference blocks identified by two MVs.

A LIC model constructor 1505 uses the current samples and references samples retrieved from the reconstructed picture buffer 1450 to derive a LIC model 1510 by regression as described in Section II above. The current samples may be samples in a current template neighboring the current block, while the reference samples may be samples in a reference template neighboring a reference block. The video encoder 1400 may then apply the LIC model 1510 to the initial predictor 1515 to generate a LIC predictor 1525. This LIC predictor 1525 may serve as the final predictor of the current block and as the predicted pixel data 1413. Once generated, the LIC model 1510 and the information related to its derivation may be stored in a LIC model storage 1535.

In some embodiments, when the current block is coded by bi-prediction, the encoder 1400 may use the two reference blocks to derive two LIC models, and apply the two LIC models to generate two LIC predictors 1525. The two LIC predictors 1525 are then combined (by e.g., weighted average at a prediction generation module 1520) into the final predictor as the predicted pixel data 1413, as described in Section II.b above.

The LIC model 1510 may also be inherited from previously coded blocks. In some embodiments, when inheriting a linear model, the information related to the model's derivation are also inherited, in addition to the offset and scaling parameters of the model, the model derivation information may include selection of template region (e.g., top template or LIC_T, left template or LIC_L, left and top templates or LIC_LT), size of template region, LIC model type (linear model ax+b, LIC with location term, or multiple-tap LIC), multi-model flag, classification method for multi-model, threshold for multi-model, etc. When the LIC model 1510 is generated and used, it is stored in a LIC model storage 1535 along with the model's derivation information. When a subsequently coded block inherits the LIC linear model, a LIC information inheritor 1530 provides the linear model parameters along with its derivation information, by retrieving the information from the LIC model storage 1535. The LIC information inheritor 1530 may identify and fetch candidates of different types, such as spatial candidates (described in Section III.c above), non-adjacent spatial candidates (described in Section III.e above), temporal candidates (described in Section III.d above), and historical candidates from history tables (described in Section III.f above).

The LIC information inheritor 1530 may construct a candidate list that includes one or more candidate LIC linear models. The candidate list may include candidates of different types. History tables for implementing history candidate may be stored in the LIC model storage 1535. The LIC information inheritor 1530 may reorder the candidates in the list based on their corresponding model errors (as described in Section III.k above) so that the linear model with the lowest error for the current block may be selected by the shortest codeword. The selection of the candidate is relayed to the entropy encoder 1490 to be encoded into the bitstream 1495.

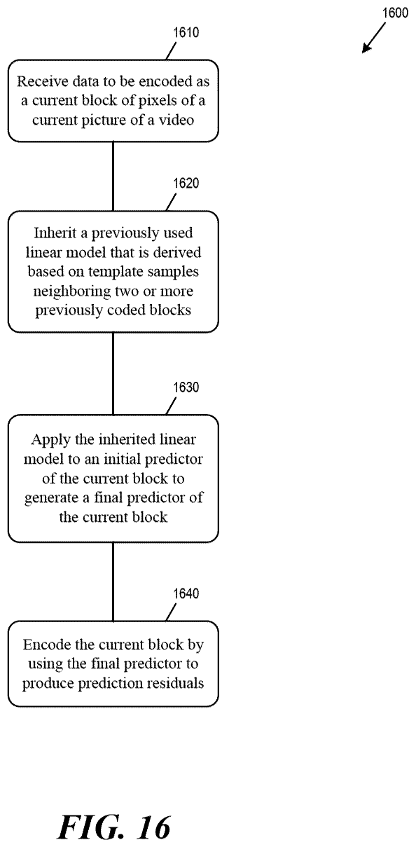

FIG. 16 conceptually illustrates a process 1600 for encoding a block of pixels using an inherited LIC linear model. In some embodiments, one or more processing units (e.g., a processor) of a computing device implementing the encoder 1400 performs the process 1600 by executing instructions stored in a computer readable medium. In some embodiments, an electronic apparatus implementing the encoder 1400 performs the process 1600.

The encoder receives (at block 1610) data to be encoded as a current block of pixels in a current picture. The encoder inherits (at block 1620) a previously used linear model for local illumination compensation (LIC), i.e., a linear model that is derived based on template samples neighboring two or more previously coded blocks; (e.g., the previous block and its reference block). In some embodiments, the encoder inheriting the linear model by inheriting scaling and offset parameters, as well as information regarding a derivation of the linear model, such as selection of template regions for providing the template samples (e.g., top template or LIC_T, left template or LIC_L, left and top templates or LIC_LT), size of template region, LIC model type (e.g., linear model ax+b, LIC with location term, or multiple-tap LIC, etc.), multi-model flag, classification method for multi-model, threshold for multi-model, etc.

The linear model may be a spatial candidate inherited from a spatial neighbor of the current block (described in Section III.c above). The linear model may be a non-adjacent spatial candidate inherited from a non-adjacent spatial neighbor of the current block (described in Section III.e above). The inherited linear model may be a historical candidate identified by using a history table that stores a history of one or more previously used linear models (described in Section III.f above). The linear model may be a temporal candidate (described in Section III.d above) inherited from a neighboring position of a corresponding position of the current block in a reference picture, with the neighboring position constrained to be within a region in the reference picture that is defined based on the corresponding position of the current block in the reference picture.

The encoder applies (at block 1630) the inherited linear model to an initial predictor of the current block to generate a final predictor of the current block. The initial predictor may be a reference block identified by a motion vector of the current block. In some embodiments, the encoder may construct a candidate list that includes one or more linear models, and the encoder may inherit the linear model by signaling a selection of the linear model from the constructed candidate list. The candidates in the candidate list may be assigned indices according to modeling errors of the candidates, where the modeling error of a candidate is computed by comparing reconstructed neighboring samples of the current block with samples generated by applying the candidate linear model to neighboring samples of a reference block that is used to produce the initial predictor. The encoder encodes (at block 1640) the current block by using the final predictor to produce prediction residuals.

### V. Example Video Decoder

In some embodiments, an encoder may signal (or generate) one or more syntax element in a bitstream, such that a decoder may parse said one or more syntax element from the bitstream.

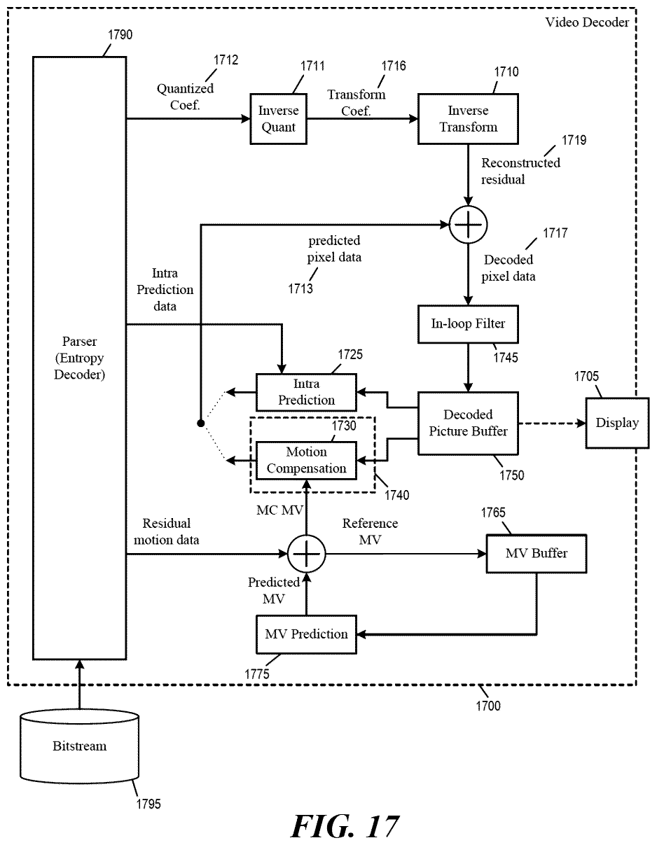

FIG. 17 illustrates an example video decoder 1700 that may implement LIC. As illustrated, the video decoder 1700 is an image-decoding or video-decoding circuit that receives a bitstream 1795 and decodes the content of the bitstream into pixel data of video frames for display. The video decoder 1700 has several components or modules for decoding the bitstream 1795, including some components selected from an inverse quantization module 1711, an inverse transform module 1710, an intra-prediction module 1725, a motion compensation module 1730, an in-loop filter 1745, a decoded picture buffer 1750, a MV buffer 1765, a MV prediction module 1775, and a parser 1790. The motion compensation module 1730 is part of an inter-prediction module 1740.

In some embodiments, the modules 1710-1790 are modules of software instructions being executed by one or more processing units (e.g., a processor) of a computing device. In some embodiments, the modules 1710-1790 are modules of hardware circuits implemented by one or more ICs of an electronic apparatus. Though the modules 1710-1790 are illustrated as being separate modules, some of the modules can be combined into a single module.

The parser 1790 (or entropy decoder) receives the bitstream 1795 and performs initial parsing according to the syntax defined by a video-coding or image-coding standard. The parsed syntax element includes various header elements, flags, as well as quantized data (or quantized coefficients) 1712. The parser 1790 parses out the various syntax elements by using entropy-coding techniques such as context-adaptive binary arithmetic coding (CABAC) or Huffman encoding.

The inverse quantization module 1711 de-quantizes the quantized data (or quantized coefficients) 1712 to obtain transform coefficients, and the inverse transform module 1710 performs inverse transform on the transform coefficients 1716 to produce reconstructed residual signal 1719. The reconstructed residual signal 1719 is added with predicted pixel data 1713 from the intra-prediction module 1725 or the motion compensation module 1730 to produce decoded pixel data 1717. The decoded pixels data are filtered by the in-loop filter 1745 and stored in the decoded picture buffer 1750. In some embodiments, the decoded picture buffer 1750 is a storage external to the video decoder 1700. In some embodiments, the decoded picture buffer 1750 is a storage internal to the video decoder 1700.

The intra-prediction module 1725 receives intra-prediction data from bitstream 1795 and according to which, produces the predicted pixel data 1713 from the decoded pixel data 1717 stored in the decoded picture buffer 1750. In some embodiments, the decoded pixel data 1717 is also stored in a line buffer (not illustrated) for intra-picture prediction and spatial MV prediction.

In some embodiments, the content of the decoded picture buffer 1750 is used for display. A display device 1705 either retrieves the content of the decoded picture buffer 1750 for display directly, or retrieves the content of the decoded picture buffer to a display buffer. In some embodiments, the display device receives pixel values from the decoded picture buffer 1750 through a pixel transport.

The motion compensation module 1730 produces predicted pixel data 1713 from the decoded pixel data 1717 stored in the decoded picture buffer 1750 according to motion compensation MVs (MC MVs). These motion compensation MVs are decoded by adding the residual motion data received from the bitstream 1795 with predicted MVs received from the MV prediction module 1775.

The MV prediction module 1775 generates the predicted MVs based on reference MVs that were generated for decoding previous video frames, e.g., the motion compensation MVs that were used to perform motion compensation. The MV prediction module 1775 retrieves the reference MVs of previous video frames from the MV buffer 1765. The video decoder 1700 stores the motion compensation MVs generated for decoding the current video frame in the MV buffer 1765 as reference MVs for producing predicted MVs.

The in-loop filter 1745 performs filtering or smoothing operations on the decoded pixel data 1717 to reduce the artifacts of coding, particularly at boundaries of pixel blocks. In some embodiments, the filtering or smoothing operations performed by the in-loop filter 1745 include deblock filter (DBF), sample adaptive offset (SAO), and/or adaptive loop filter (ALF). In some embodiments, luma mapping chroma scaling (LMCS) is performed before the loop filters.

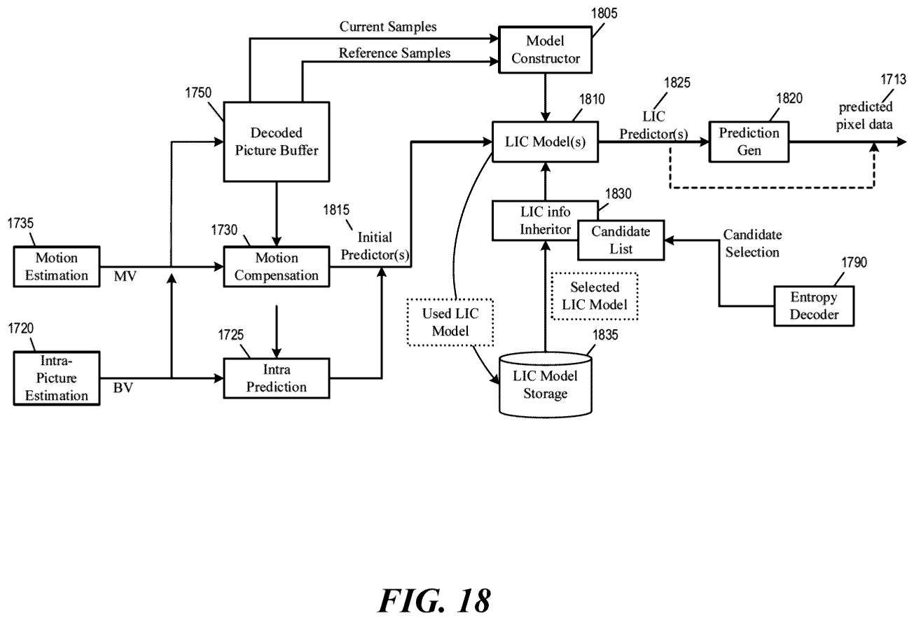

FIG. 18 illustrates portions of the video decoder 1700 that implement inheriting LIC information. The current block may be initially coded by inter-prediction or intra-prediction (motion compensation module 1730 or intra prediction module 1725), which generates an initial predictor 1815. When the current block is coded by inter-prediction, the initial predictor 1815 may be a reference block in a reference picture identified by a motion vector (MV). When the current block is coded by bidirectional inter-prediction, the initial predictor 1815 may include two reference blocks identified by two MVs.

A LIC model constructor 1805 uses the current samples and references samples retrieved from the decoded picture buffer 1750 to derive a LIC model 1810 by regression as described in Section II above. The current samples may be samples in a current template neighboring the current block, while the reference samples may be samples in a reference template neighboring the reference block. The video decoder 1700 may then apply the LIC model 1810 to the initial predictor 1815 to generate a LIC predictor 1825. This LIC predictor 1825 may serve as the final predictor of the current block and as the predicted pixel data 1713. Once generated, the LIC model 1810 and the information related to its derivation may be stored in a LIC model storage 1835.

In some embodiments, when the current block is coded by bi-prediction, the decoder 1700 may use two reference blocks to derive two LIC models, and apply the two LIC models to generate two LIC predictors 1825.

The two LIC predictors 1825 are then combined (by e.g., weighted average at a prediction generation module 1820) into the final predictor as the predicted pixel data 1713, as described in Section II.b above.

The LIC model 1810 may also be inherited from previously coded blocks. In some embodiments, when inheriting a linear model, the information related to the model's derivation are also inherited, in addition to the offset and scaling parameters of the model. The model derivation information may include selection of template region (e.g., top template or LIC_T, left template or LIC_L, left and top templates or LIC_LT), size of template region, LIC model type (linear model ax+b, LIC with location term, or multiple-tap LIC), multi-model flag, classification method for multi-model, threshold for multi-model, etc. When the LIC model 1810 is generated and used, it is stored in a LIC model storage 1835 along with the model's derivation information. When a subsequently coded block inherits the LIC linear model, a LIC information inheritor 1830 provides the linear model parameters along with its derivation information, by retrieving the information from the LIC model storage 1835. The LIC information inheritor 1830 may identify and fetch candidates of different types, such as spatial candidates (described in Section III.c above), non-adjacent spatial candidates (described in Section III.e above), temporal candidates (described in Section III.d above), and historical candidates from history tables (described in Section III.f above).

The LIC information inheritor 1830 may construct a candidate list that includes one or more candidate LIC linear models. The history tables for implementing history candidates may be stored in the LIC model storage 1835. The LIC information inheritor 1830 may reorder the candidates in the list based on their corresponding model errors (as described in Section III.k above) so that the linear model with the lowest error for the current block may be selected by the shortest codeword. The video decoder 1700 may receive the selection of the candidate from the entropy decoder 1790 that is parsed from the bitstream 1795.

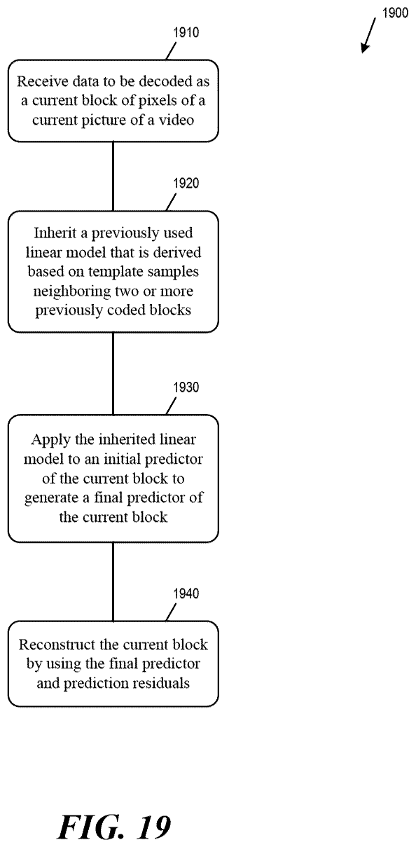

FIG. 19 conceptually illustrates a process 1900 for decoding a block of pixels using an inherited LIC linear model. In some embodiments, one or more processing units (e.g., a processor) of a computing device implementing the decoder 1700 performs the process 1900 by executing instructions stored in a computer readable medium. In some embodiments, an electronic apparatus implementing the decoder 1700 performs the process 1900.

The decoder receives (at block 1910) data to be decoded as a current block of pixels in a current picture. The decoder inherits (at block 1920) a previously used linear model for local illumination compensation (LIC), i.e., a linear model that is derived based on template samples neighboring two or more previously coded blocks; (e.g., the previous block and its reference block). In some embodiments, the decoder inheriting the linear model by inheriting scaling and offset parameters, as well as information regarding a derivation of the linear model, such as selection of template regions for providing the template samples (e.g., top template or LIC_T, left template or LIC_L, left and top templates or LIC_LT), size of template region, LIC model type (e.g., linear model ax+b, LIC with location term, or multiple-tap LIC, etc.), multi-model flag, classification method for multi-model, threshold for multi-model, etc.

The linear model may be a spatial candidate inherited from a spatial neighbor of the current block (described in Section III.c above). The linear model may be a non-adjacent spatial candidate inherited from a non-adjacent spatial neighbor of the current block (described in Section III.e above). The inherited linear model may be a historical candidate identified by using a history table that stores a history of one or more previously used linear models (described in Section III.f above). The linear model may be a temporal candidate (described in Section III.d above) inherited from a neighboring position of a corresponding position of the current block in a reference picture, with the neighboring position constrained to be within a region in the reference picture that is defined based on the corresponding position of the current block in the reference picture.

The decoder applies (at block 1930) the inherited linear model to an initial predictor of the current block to generate a final predictor of the current block. The initial predictor may be a reference block identified by a motion vector of the current block. In some embodiments, the decoder may construct a candidate list that includes one or more linear models, and the decoder may inherit the linear model by receiving a selection of the linear model from the constructed candidate list. The candidates in the candidate list may be assigned indices according to modeling errors of the candidates, where the modeling error of a candidate is computed by comparing reconstructed neighboring samples of the current block with samples generated by applying the candidate linear model to neighboring samples of a reference block that is used to produce the initial predictor. The decoder reconstructs (at block 1940) the current block by using the final predictor and prediction residuals. The decoder may then provide the reconstructed current block for display as part of the reconstructed current picture.

### VI. Example Electronic System

Many of the above-described features and applications are implemented as software processes that are specified as a set of instructions recorded on a computer readable storage medium (also referred to as computer readable medium). When these instructions are executed by one or more computational or processing unit(s) (e.g., one or more processors, cores of processors, or other processing units), they cause the processing unit(s) to perform the actions indicated in the instructions. Examples of computer readable media include, but are not limited to, CD-ROMs, flash drives, random-access memory (RAM) chips, hard drives, erasable programmable read only memories (EPROMs), electrically erasable programmable read-only memories (EEPROMs), etc. The computer readable media does not include carrier waves and electronic signals passing wirelessly or over wired connections.

In this specification, the term “software” is meant to include firmware residing in read-only memory or applications stored in magnetic storage which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the present disclosure. In some embodiments, the software programs, when installed to operate on one or more electronic systems, define one or more specific machine implementations that execute and perform the operations of the software programs.

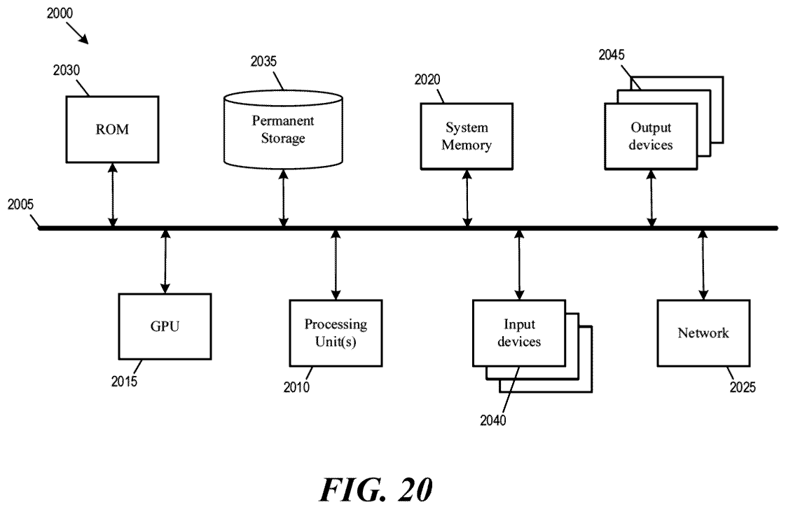

FIG. 20 conceptually illustrates an electronic system 2000 with which some embodiments of the present disclosure are implemented. The electronic system 2000 may be a computer (e.g., a desktop computer, personal computer, tablet computer, etc.), phone, PDA, or any other sort of electronic device. Such an electronic system includes various types of computer readable media and interfaces for various other types of computer readable media. Electronic system 2000 includes a bus 2005, processing unit(s) 2010, a graphics-processing unit (GPU) 2015, a system memory 2020, a network 2025, a read-only memory 2030, a permanent storage device 2035, input devices 2040, and output devices 2045.

The bus 2005 collectively represents all system, peripheral, and chipset buses that communicatively connect the numerous internal devices of the electronic system 2000. For instance, the bus 2005 communicatively connects the processing unit(s) 2010 with the GPU 2015, the read-only memory 2030, the system memory 2020, and the permanent storage device 2035.

From these various memory units, the processing unit(s) 2010 retrieves instructions to execute and data to process in order to execute the processes of the present disclosure. The processing unit(s) may be a single processor or a multi-core processor in different embodiments. Some instructions are passed to and executed by the GPU 2015. The GPU 2015 can offload various computations or complement the image processing provided by the processing unit(s) 2010.

The read-only-memory (ROM) 2030 stores static data and instructions that are used by the processing unit(s) 2010 and other modules of the electronic system. The permanent storage device 2035, on the other hand, is a read-and-write memory device. This device is a non-volatile memory unit that stores instructions and data even when the electronic system 2000 is off. Some embodiments of the present disclosure use a mass-storage device (such as a magnetic or optical disk and its corresponding disk drive) as the permanent storage device 2035.

Other embodiments use a removable storage device (such as a floppy disk, flash memory device, etc., and its corresponding disk drive) as the permanent storage device. Like the permanent storage device 2035, the system memory 2020 is a read-and-write memory device. However, unlike storage device 2035, the system memory 2020 is a volatile read-and-write memory, such a random access memory. The system memory 2020 stores some of the instructions and data that the processor uses at runtime. In some embodiments, processes in accordance with the present disclosure are stored in the system memory 2020, the permanent storage device 2035, and/or the read-only memory 2030. For example, the various memory units include instructions for processing multimedia clips in accordance with some embodiments. From these various memory units, the processing unit(s) 2010 retrieves instructions to execute and data to process in order to execute the processes of some embodiments.

The bus 2005 also connects to the input and output devices 2040 and 2045. The input devices 2040 enable the user to communicate information and select commands to the electronic system. The input devices 2040 include alphanumeric keyboards and pointing devices (also called “cursor control devices”), cameras (e.g., webcams), microphones or similar devices for receiving voice commands, etc. The output devices 2045 display images generated by the electronic system or otherwise output data. The output devices 2045 include printers and display devices, such as cathode ray tubes (CRT) or liquid crystal displays (LCD), as well as speakers or similar audio output devices. Some embodiments include devices such as a touchscreen that function as both input and output devices.

Finally, as shown in FIG. 20, bus 2005 also couples electronic system 2000 to a network 2025 through a network adapter (not shown). In this manner, the computer can be a part of a network of computers (such as a local area network (“LAN”), a wide area network (“WAN”), or an Intranet, or a network of networks, such as the Internet. Any or all components of electronic system 2000 may be used in conjunction with the present disclosure.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra-density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, many of the above-described features and applications are performed by one or more integrated circuits, such as application specific integrated circuits (ASICs) or field programmable gate arrays (FPGAs). In some embodiments, such integrated circuits execute instructions that are stored on the circuit itself. In addition, some embodiments execute software stored in programmable logic devices (PLDs), ROM, or RAM devices.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium,” “computer readable media,” and “machine readable medium” are entirely restricted to tangible, physical objects that store information in a form that is readable by a computer. These terms exclude any wireless signals, wired download signals, and any other ephemeral signals.

While the present disclosure has been described with reference to numerous specific details, one of ordinary skill in the art will recognize that the present disclosure can be embodied in other specific forms without departing from the spirit of the present disclosure. In addition, a number of the figures (including FIG. 16 and FIG. 19) conceptually illustrate processes. The specific operations of these processes may not be performed in the exact order shown and described. The specific operations may not be performed in one continuous series of operations, and different specific operations may be performed in different embodiments. Furthermore, the process could be implemented using several sub-processes, or as part of a larger macro process. Thus, one of ordinary skill in the art would understand that the present disclosure is not to be limited by the foregoing illustrative details, but rather is to be defined by the appended claims.

### ADDITIONAL NOTES

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermediate components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A video coding method comprising:
receiving data to be encoded or decoded as a current block of pixels of a current picture of a video;
inheriting a previously used linear model that is derived based on template samples neighboring two or more previously coded blocks;
applying the inherited linear model to an initial predictor of the current block to generate a final predictor of the current block; and
encoding or decoding the current block by using the final predictor.

2. The video coder of claim 1, wherein the linear model is for local illumination compensation (LIC).

3. The video coder of claim 1, wherein inheriting the linear model comprises inheriting information regarding a derivation of the linear model.

4. The video coder of claim 1, wherein inheriting the linear model comprises inheriting a scaling parameter and an offset parameter.

5. The video coder of claim 1, wherein the initial predictor is a reference block identified by a motion vector of the current block.

6. The video coder of claim 1, wherein the linear model is inherited from a spatial neighbor of the current block.

7. The video coder of claim 1, wherein the linear model is inherited from a non-adjacent spatial neighbor of the current block.

8. The video coder of claim 1, wherein the inherited linear model is identified by using a history table that stores a history of one or more previously used linear models.

9. The video coder of claim 1, wherein the linear model is inherited from a neighboring position of a corresponding position of the current block in a reference picture.

10. The video coder of claim 9, wherein the neighboring position is constrained to be within a region in the reference picture that is defined based on the corresponding position of the current block in the reference picture.

11. The video coder of claim 1, further comprising constructing a candidate list that includes one or more linear models, wherein inheriting the linear model comprises signaling or receiving a selection of the linear model from the constructed candidate list.

12. The video coder of claim 11, wherein candidates in the candidate list are assigned indices according to modeling errors of the candidates, wherein the modeling error of a candidate is computed by comparing reconstructed neighboring samples of the current block with samples generated by applying the candidate linear model to neighboring samples of a reference block.

13. An electronic apparatus comprising:
a video coder circuit configured to perform operations comprising:
receiving data to be encoded or decoded as a current block of pixels of a current picture of a video;
inheriting a previously used linear model that is derived based on template samples neighboring two or more previously coded blocks;
applying the inherited linear model to an initial predictor of the current block to generate a final predictor of the current block; and
encoding or decoding the current block by using the final predictor.

14. A video decoding method comprising:
receiving data to be decoded as a current block of pixels of a current picture of a video;
inheriting a previously used linear model that is derived based on template samples neighboring two or more previously coded blocks;
applying the inherited linear model to an initial predictor of the current block to generate a final predictor of the current block; and
reconstructing the current block by using the final predictor.

15. A video encoding method comprising:
receiving data to be encoded as a current block of pixels of a current picture of a video;
inheriting a previously used linear model that is derived based on template samples neighboring two or more previously coded blocks;
applying the inherited linear model to an initial predictor of the current block to generate a final predictor of the current block; and
encoding the current block by using the final predictor.
